(19) United States
(12) Patent Application Publication
(10) Pub. No.: US 2024/0232929 A1
(43) Pub. Date: Jul. 11, 2024

(54) COMMUNICATIONS SERVER APPARATUS, COMMUNICATIONS DEVICE, METHODS AND COMMUNICATIONS SYSTEM FOR MANAGING A SUBSCRIPTION PLAN FOR A PLURALITY OF OFFERING CATEGORIES

(71) Applicant: GRABTAXI HOLDINGS PTE. LTD., Singapore (SG)

(72) Inventors: Viet Cuong NGUYEN, Singapore (SG); Raghav GARG, Singapore (SG); Chun Kai PHANG, Singapore (SG)

(21) Appl. No.: 18/561,951

(22) PCT Filed: Jun. 8, 2022
(86) PCT No.: PCT/SG2022/050388

§ 371 Date: Nov. 17, 2023

(30) Foreign Application Priority Data
Jun. 29, 2021 (SG) 10202107158P

(51) Int. Cl. G06Q 30/0207

(52) U.S. Cl. CPC G06Q 30/0222

(57) ABSTRACT

A communications server apparatus for managing a subscription plan for a plurality of offering categories is provided, which, in response to receiving subscription request data comprising at least one data field indicative of a request by a user for subscribing to the subscription plan for the plurality of offering categories, generate, in one or more data records, subscription data indicative of the subscription plan, the subscription data comprising a plurality of offering data for a corresponding plurality of offering categories to be covered in the subscription plan, wherein, for each offering data, the offering data comprises token data indicative of tokens associated with the corresponding offering category, the tokens being usable for offerings in the corresponding offering category, and communicate the subscription plan to a communications device of the user.

### TECHNICAL FIELD

The invention relates generally to the fields of communications and e-commerce. One aspect of the invention relates to a communications server apparatus for managing a subscription plan for a plurality of offering categories. Other aspects of the invention relate to a communications device for managing a subscription plan for a plurality of offering categories, a communications system for managing a subscription plan for a plurality of offering categories, and methods for managing a subscription plan for a plurality of offering categories.

One aspect of the invention has particular, but not exclusive, applications to managing and/or subscribing to a subscription plan for a plurality of offering categories. Offerings (e.g., products and/or services) for or falling under a plurality of offering categories may be managed or covered by one subscription plan.

### BACKGROUND

Current subscription models are unable to satisfy the needs of various parties to the subscription models, which include the service users (e.g., users, customers, etc.), the service providers (e.g., drivers, merchants, etc.) and the administrator or facilitator of the subscription models/services.

For the service users or customers, most of the existing subscriptions are designed in a generic way with assumption of “one size fits all”, leading to a few gaps and opportunity for the administrator of the subscription services. The existing subscription design for a SuperApp does not meet the needs and spending habits of all the users.

For service providers, for example, drivers who provide transport-related services, there are lost chances of increasing earnings because service users tend to use more of the product(s) that the users already paid for in a subscription plan.

For the administrator of the subscription services or plans, there are lost chances to encourage users to use other products that, in turn, further leads to lost chances to increase revenue and customer retention.

### SUMMARY

Aspects of the invention are as set out in the independent claims. Some optional features are defined in the dependent claims.

Implementation of the techniques disclosed herein may provide significant technical advantages.

Techniques disclosed herein may provide a subscription plan to cover a plurality of offering categories in the subscription plan, where there may be a plurality of offerings (e.g., products and/or services) offered in each offering category. Such an implementation may be managed or covered by a (one) subscription plan. The subscription plan for the plurality of offering categories may be managed via a (one) corresponding App provided by the administrator or facilitator managing the subscription plan. A user wishing to sign up to the subscription plan for a plurality of offering categories may do so via the (one) App that may be installed or resident on a communications device of the user. The communications device, with the App, may be used to interact with the backend (e.g., communications server apparatus) managing the subscription plan.

Using one subscription plan and/or one App for managing the subscription plan for a plurality of offering categories help to improve efficiency in the usage of resources, bandwidth and processing load, on the communications server apparatus and the user communications device. The communications server apparatus and the user communications device may just need to access and manage one subscription plan compared to a plurality of subscription plans where one plan is required for each offering category. Thus, techniques disclosed herein may improve the processing speed and bandwidth, and lighten the processing load on the communications server apparatus and the user communications device. Further, the use of one App may also improve the processing speed and bandwidth, and lighten the processing load on the communications server apparatus and the user communications device as the communications server apparatus may just need to interface with one App, and as the user just needs to launch one App to manage the subscription plan for multiple offering categories rather than having to launch multiple Apps where one App is required for each offering category thereby causing strain on the processing load and speed of the user communications device.

Further, techniques disclosed herein may provide a subscription plan to cover a plurality of offering categories for a group of two or more group members in the subscription plan, where there may be a plurality of offerings (e.g., products and/or services) offered in each offering categories. Such an implementation may be managed or covered by the (one) subscription plan. The subscription plan for the plurality of offering categories may be managed via the (one) corresponding App that a group owner or account owner (user) may use to manage the subscription plan for the group. Using one subscription plan and/or one App for managing the subscription plan for a plurality of offering categories for a plurality of group members help to improve efficiency in the usage of resources, bandwidth, and processing load, and improve the processing speed as described herein.

Techniques disclosed herein may define time periods that a token or voucher may be usable or redeemable, as a means to balance supply and demand, as generally there are greater demands during peak hours that may potentially lead to undersupply of the required services.

Techniques disclosed herein may also implement or employ one or more machine learning (ML) models that are trained using user historical data as the training data to provide output data that may be implemented or incorporated in the subscription plan.

In an exemplary implementation, the functionality of the techniques disclosed herein may be implemented in software running on a handheld communications device, such as a mobile phone. The software which implements the functionality of the techniques disclosed herein may be contained in an “App”—a computer program, or computer program product—which the user has downloaded from an online store. When running on the, for example, user's mobile telephone, the hardware features of the mobile telephone may be used to implement the functionality described below, such as using the mobile telephone's transceiver components to establish the secure communications channel for managing a subscription plan for a plurality of offering categories.

### BRIEF DESCRIPTION OF THE DRAWINGS

The invention will now be described, by way of example only, and with reference to the accompanying drawings in which:

FIG. 1 is a schematic block diagram illustrating an exemplary communications system involving a communications server apparatus.

FIG. 2A shows a schematic block diagram illustrating a communications server apparatus for managing a subscription plan for a plurality of offering categories.

FIG. 2B shows a schematic block diagram illustrating a data record.

FIG. 2C shows a schematic block diagram illustrating architecture components of the communications server apparatus of FIG. 2A.

FIG. 2D shows a flow chart illustrating a method for managing a subscription plan for a plurality of offering categories.

FIG. 2E shows a schematic block diagram illustrating a communications device for managing a subscription plan for a plurality of offering categories.

FIG. 2F shows a flow chart illustrating a method for managing a subscription plan for a plurality of offering categories.

FIGS. 3A to 3R show an example of a process flow for a dynamic subscription front end of various embodiments.

FIGS. 4A to 4F show an example of a process flow for a dynamic subscription back end of various embodiments.

FIGS. 5A to 5L show an example of a process flow for a group management front end of various embodiments.

FIGS. 6A and 6B show an example of a process flow for a group management back end of various embodiments.

### DETAILED DESCRIPTION

For known subscription models, the administrator does not give the flexibility for users to pre-define a subscription which meets his needs before making a purchase. If users want to use transport and food services at the same time, they have to buy two different subscriptions (if available). The users do not have the option of using one subscription for multiple products. Further, the number of vouchers in one subscription plan is fixed (for example, 30 vouchers/cycle), and sometimes users cannot use all of the vouchers but they would have paid for the vouchers they haven't used. On the other hand, if the users used all vouchers before the end of the cycle, the users have to wait until the next cycle to buy a subscription again. Further, as the current system treats each user as an independent entity, the subscription vouchers cannot be shared with other users, and only the user with the subscription plan can use the subscription vouchers. There are, therefore, problems associated with known subscription models.

Various embodiments may relate to SuperApp dynamic subscription for a user or for a group (or plurality) of users or group members, for example, including friends and family. A dynamic subscription may allow a customer to design, buy and use subscription for multiple products in the same cycle at different prices. Besides that, it may also allow users to buy and share subscriptions with a number of users or group members, including friends and family.

Techniques disclosed herein may provide a custom and personalised subscription design for SuperApp customers which may allow the users to predefine and use one subscription for multiple products and/or services. These may be products and/or services for distinct sectors or categories, including but not limited to, logistics (e.g., delivery of documents, packages, parcels, goods, etc.), transport (e.g., ride-hailing services, ride-sharing services, etc.), finance (e.g., payment, banking, insurance, etc.), food (e.g., food ordering, food delivery, etc.), goods services (e.g., purchase and/or delivery of groceries, packaged goods/foods, household products, etc.), trade or handyman-related services, etc. Such a subscription design or plan allows the users to choose perimeters of the plan to suit their requirements or according to their needs. Further, such subscription model may help the administrator to achieve the SuperApp vision as this allows users to manage and share subscription with friends and family members, or other groupings. In other words, a user who subscribes or signs up to a subscription according to the techniques disclosed herein may be able to or may choose to share the subscription with one or more other group members (e.g., friends and/or family members) so that the other group member(s) may also be able to enjoy or consume the product(s) and/or service(s) offered under the (single) subscription plan. The subscription plan may be associated with one or single account, meaning that the group members covered under the subscription plan may be managed within one (shared) account. The user who signs up to the subscription plan may be the account owner, who may choose to include or enroll other group member(s) under the same account to share the offerings under the subscription plan among the account owner and the other group member(s).

The techniques disclosed herein may provide users with flexibility and freedom to choose the offering categories and vouchers that they would like to use for a given period of time. If users do not want to choose on their own, a default or defined number of vouchers may be suggested or provided based on one or more predictive models, for example, for various categories such as “Transport” (e.g., rides), “Food” (e.g., ordering (which may include payment) and delivery of foods), “Mart” (e.g., on-demand goods ordering (which may include payment) and delivery service) and “Express” (e.g., on-demand delivery service for items such as documents, parcels, etc.). The techniques disclosed herein may leverage or employ one or more machine learning (ML) models to predict user behaviour and demand to personalise subscription plans, which would also help shape better marketplace health. The techniques disclosed herein may allow users to buy subscription plans anytime whenever they need, even before the cycle end, but which may come with a higher price and the corresponding vouchers may be valid until the last day of the current cycle.

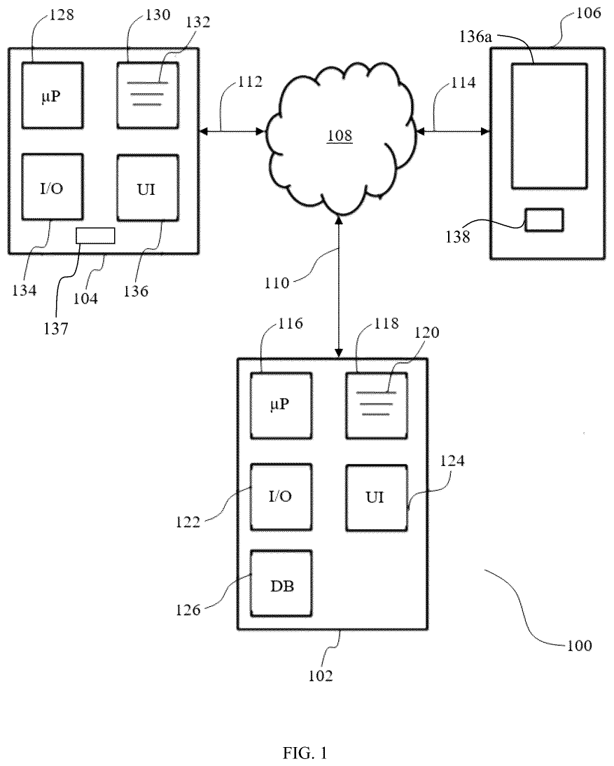

Referring first to FIG. 1, a communications system 100 is illustrated, which may be applicable in various embodiments. The communications system 100 may be for managing a subscription plan for a plurality of offering categories.

The communications system 100 includes a communications server apparatus 102, a first user (or client) communications device 104 and a second user (or client) communications device 106. These devices 102, 104, 106 are connected in or to the communications network 108 (for example, the Internet) through respective communications links 110, 112, 114 implementing, for example, internet communications protocols. The communications devices 104, 106 may be able to communicate through other communications networks, such as public switched telephone networks (PSTN networks), including mobile cellular communications networks, but these are omitted from FIG. 1 for the sake of clarity. It should be appreciated that there may be one or more other communications devices similar to the devices 104, 106.

The communications server apparatus 102 may be a single server as illustrated schematically in FIG. 1, or have the functionality performed by the communications server apparatus 102 distributed across multiple server components. In the example of FIG. 1, the communications server apparatus 102 may include a number of individual components including, but not limited to, one or more microprocessors (μP) 116, a memory 118 (e.g., a volatile memory such as a RAM (random access memory)) for the loading of executable instructions 120, the executable instructions 120 defining the functionality the server apparatus 102 carries out under control of the processor 116. The communications server apparatus 102 may also include an input/output (I/O) module (which may be or include a transmitter module and/or a receiver module) 122 allowing the server apparatus 102 to communicate over the communications network 108. User interface (UI) 124 is provided for user control and may include, for example, one or more computing peripheral devices such as display monitors, computer keyboards and the like. The communications server apparatus 102 may also include a database (DB) 126, the purpose of which will become readily apparent from the following discussion.

The communications server apparatus 102 may be for managing a subscription plan for a plurality of offering categories.

The user communications device 104 may include a number of individual components including, but not limited to, one or more microprocessors (μP) 128, a memory 130 (e.g., a volatile memory such as a RAM) for the loading of executable instructions 132, the executable instructions 132 defining the functionality the user communications device 104 carries out under control of the processor 128. User communications device 104 also includes an input/output (I/O) module (which may be or include a transmitter module and/or a receiver module) 134 allowing the user communications device 104 to communicate over the communications network 108. A user interface (UI) 136 is provided for user control. If the user communications device 104 is, say, a smart phone or tablet device, the user interface 136 may have a touch panel display as is prevalent in many smart phone and other handheld devices. Alternatively, if the user communications device 104 is, say, a desktop or laptop computer, the user interface may have, for example, one or more computing peripheral devices such as display monitors, computer keyboards and the like. User communications device 104 may also include satnav components 137, which allow user communications device 104 to conduct a measurement or at least approximate the geolocation of user communications device 104 by receiving, for example, timing signals from global navigation satellite system (GNSS) satellites through GNSS network using communications channels, as is known.

The user communications device 106 may be, for example, a smart phone or tablet device with the same or a similar hardware architecture to that of the user communications device 104. User communications device 106, has, amongst other things, user interface 136a in the form of a touchscreen display and satnav components 138. User communications device 106 may be able to communicate with cellular network base stations through cellular telecommunications network using communications channels. User communications device 106 may be able to approximate its geolocation by receiving timing signals from the cellular network base stations through cellular telecommunications network as is known. Of course, user communications device 104 may also be able to approximate its geolocation by receiving timing signals from the cellular network base stations and user communications device 106 may be able to approximate its geolocation by receiving timing signals from the GNSS satellites, but these arrangements are omitted from FIG. 1 for the sake of simplicity.

The user communications device 104 and/or the user communications device 106 may be for managing a subscription plan for a plurality of offering categories. The user communications device 104 and/or the user communications device 106 may be for communicating with the communications server apparatus 102 for managing a subscription plan for a plurality of offering categories.

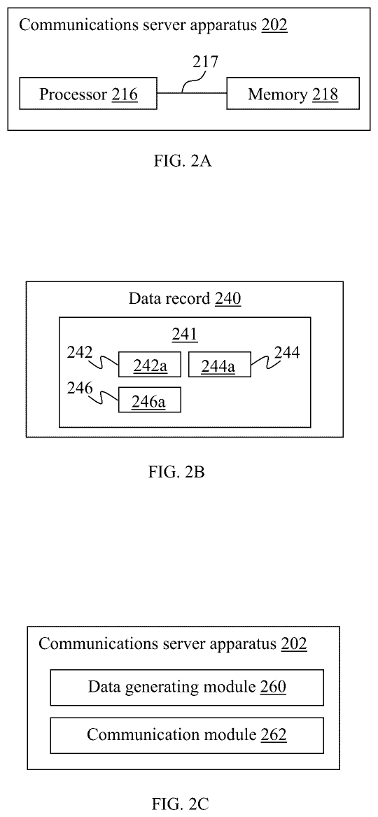

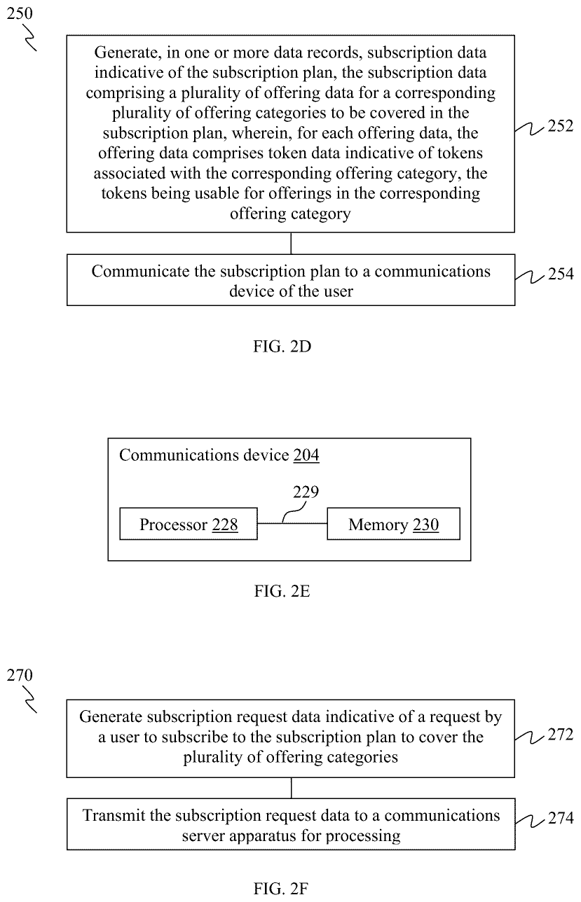

FIG. 2A shows a schematic block diagram illustrating a communications server apparatus 202 for managing a subscription plan for a plurality of offering categories, while FIG. 2B shows a schematic block diagram illustrating a data record 240 that may be generated by the communications server apparatus 202.

The communications server apparatus 202 includes a processor 216 and a memory 218, where the communications server apparatus 202 is configured, under control of the processor 216 to execute instructions in the memory 218 to, in response to receiving subscription request data including at least one data field indicative of a request by a user for subscribing to the subscription plan for the plurality of offering categories, generate, in one or more data records 240, subscription data 241 indicative of the subscription plan, the subscription data 241 including a plurality of offering data (three offering data 242, 244, 246 are illustratively shown in FIG. 2B) for a corresponding plurality of offering categories to be covered in the subscription plan, wherein, for each offering data 242, 244, 246, the offering data 242, 244, 246 includes token data 242a, 244a, 246a indicative of tokens associated with the corresponding offering category, the tokens being usable for offerings in the corresponding offering category, and communicate the subscription plan to a communications device of the user. The processor 216 and the memory 218 may be coupled to each other (as represented by the line 217), e.g., physically coupled and/or electrically coupled. The processor 216 may be as described in the context of the processor 116 (FIG. 1) and/or the memory 218 may be as described in the context of the memory 118 (FIG. 1).

In other words, there may be provided a communications server apparatus 202 for managing a subscription plan for a plurality of (distinct) offering categories. A user may wish to subscribe to a subscription plan covering the plurality of offering categories. The user may wish to put in a request for subscribing to the subscription plan. The request may, for example, be made through one (single) App provided by an administrator or token issuer that manages the subscription plan. In response to receiving subscription request data having at least one data field indicative of the request by the user for subscribing to the subscription plan for the plurality of offering categories, the communications server apparatus 202 may generate, in one or more data records 240, subscription data 241 indicative of the subscription plan. The subscription data 241 may include information related to the subscription plan. Non-limiting examples of such information may include detail about the user, the type of subscription plan, the price of the subscription plan, etc.

The subscription data 241 may include a plurality of offering data 242, 244, 246 for a corresponding plurality of offering categories to be covered in (or under) the subscription plan. For each offering data 242, 244, 246 (of each offering category), the offering data may include token data 242a, 244a, 246a (e.g., voucher data) indicative of tokens (e.g., vouchers) associated with (or corresponding to) the corresponding offering category. The tokens may be usable (or redeemable) for offerings in the corresponding offering category.

The communications server apparatus 202 may then communicate (or transmit) the subscription plan to a communications device of the user (for presentation of the subscription plan to the user). This may include communicating or transmitting the plurality of offering data 242, 244, 246 for presentation of the subscription plan to the communications device of the user. In communicating the plurality of offering data 242, 244, 246 to the (user) communications device, the token data 242a, 244a, 246a may be communicated or transmitted to the communications device.

The subscription for the plurality of offering categories and their corresponding tokens may be managed through one (single) subscription plan covering the multiple offering categories. The user may use one (single) App to manage the subscription plan covering the multiple offering categories and their corresponding tokens.

For each offering data 242, 244, 246, the offering data 242, 244, 246 may be or may include data indicative of the type of the offering category (e.g., transport-related category or service). The offering data 242, 244, 246 may further include data indicative of one or more particular or defined offerings (e.g., ride-hailing services, etc.) belonging to the corresponding offering category.

In the context of various embodiments, an offering in an offering category may include a product or a service belonging to the offering category. Tokens associated with a corresponding offering category may be used for a plurality of offerings in the corresponding offering category. The plurality of offerings that may be covered may be in the form of products and/or services.

As non-limiting examples, the plurality of offering categories may include, but not limited to, transport-related category (as examples, the offerings in the transport-related category may include ride-hailing services, ride-sharing services, etc.), logistics-related category (example offerings may include delivery of documents, packages, parcels, goods, etc.), finance-related category (example offerings may include payment, banking, insurance, etc.), food-related category (example offerings may include food ordering, food delivery, etc.), goods-related category (example offerings may include purchase and/or delivery of groceries, packaged goods/foods, household products, etc.), trade or handyman-related category (example offerings may include plumbing services, pest control services, etc).

In the context of various embodiments, a token may include, but not limited to, a voucher. The voucher may have an associated value which may be used to offset against a cost of an offering that the user may wish to purchase or use in a corresponding offering category that the voucher is associated with. As a non-limiting example, the user may wish to book a ride-hailing service (in the category of transport-related services), and the user may wish to use a voucher associated with the transport-related category provided in the subscription plan that the user subscribes to so as to offset against the cost of the ride-hailing service. In this way, the voucher may provide a discount to the cost of the ride-hailing service.

For the each offering data 242, 244, 246, the token data 242a, 244a, 246a may include token number data indicative of a number (or number count) of the tokens associated with the corresponding offering category.

For the each offering data 242, 244, 246, the token data 242a, 244a, 246a may include time data indicative of one or more time periods that the tokens are available (for use or redemption). The time period(s) may, for example, cover peak hours and non-peak hours. Other forms of time periods may be employed. As non-limiting examples, a time period may be defined in terms of a morning period, an afternoon period, an evening period, or in terms of specific hours, e.g., between 10:00 am and 12:00 pm, between 10:00 am and 2:00 pm, between 17:00 pm and 20:00 pm, etc.

Each token data 242a, 244a, 246a may further include token offset data indicative of a cost offset value against a cost of an offering in the corresponding offering category.

For generating the subscription data 241, the communications server apparatus 202 may generate (in the one or more data records 240) the token data 242a, 244a, 246a for the plurality of offering categories based on output data generated by one or more machine learning (ML) models trained using user historical data. The ML model(s) may be trained based on relevant or related user historical data as the input data. In other words, the user historical data may be used as training data to be inputted to the ML model(s). The ML model(s) may be employed to provide output data corresponding or related to the token data 242a, 244a, 246a. For example, the ML model(s) may output suggestions for the tokens (and their related parameters, e.g., number of tokens, time periods that the tokens are available or redeemable, etc.).

In response to receiving user input data corresponding to the tokens (indicative of a change to one or more parameters of the tokens), for generating the subscription data 241, the communications server apparatus 202 may modify the token data 242a, 244a, 246a (for the plurality of offering categories) in accordance with the user input data. This may allow change to one or more parameters (e.g., number of tokens) of the tokens due to a manual change or adjustment by the user.

In response to receiving add request data indicative of a request by the user to include an additional offering category in the subscription plan, for generating the subscription data 241, the communications server apparatus 202 may further generate additional offering data for the additional offering category, the additional offering data including additional token data indicative of tokens associated with the additional offering category. This may allow the user to add one or more new or additional offering categories, with the corresponding tokens, to the subscription plan. The additional token data may include one or more of token number data indicative of a number of the tokens associated with the additional offering category, time data indicative of one or more time periods that the tokens are available (for use or redemption), and token offset data indicative of a cost offset value against a cost of an offering in the additional offering category.

In response to receiving group request data indicative of a request by the user to include a group having the user as a group member and one or more additional group members in the subscription plan, for generating the subscription data 241, the communications server apparatus 202 may further generate, for each additional group member, a plurality of offering data for a corresponding plurality of offering categories to be covered in (or under) the subscription plan, wherein, for each offering data (for the each additional group member), the offering data may include token data (e.g., voucher data) indicative of tokens associated with (or corresponding to) the corresponding offering category (for the each additional group member). The user may be the account owner or group owner of the group. To be included as a group member of the group, the members would need to be using the App provided by the administrator or token issuer that manages the subscription plan, which may be the same App used by the user to subscribe to the subscription plan. The one or more additional group members included in the group may be removed from the group, and, consequently, from the subscription plan.

For the each offering data for the each additional group member, the token data may include token number data indicative of a number (or number count) of the tokens associated with the corresponding offering category.

For the each offering data for the each additional group member, the token data may include time data indicative of one or more time periods that the tokens are available (for use or redemption).

In various embodiments, for generating the subscription data 241, the communications server apparatus 202 may generate (in the one or more data records 240) the token data for the plurality of offering categories for the each additional group member based on output data generated by one or more machine learning (ML) models trained using user historical data. The one or more ML models and/or the user historical data for the purpose of the user and the each additional group member may be the same or different.

In response to receiving additional user input data corresponding to the tokens for the each additional group member (indicative of a change to one or more parameters of the tokens), for generating the subscription data 241, the communications server apparatus 202 may further modify the token data for the each additional group member in accordance with the additional user input data.

In response to receiving confirmation data including at least one data field indicative of a confirmation (or approval) by the user to the subscription plan, the communications server apparatus 202 may further store the subscription data 241 in a database. The subscription data 241 (and the database) may be saved or stored, for example, in the memory 218 of the communications server apparatus 202, or in another memory accessible by the communications server apparatus 202.

In the context of various embodiments, the one or more data records 240 may include one or more subscription data fields and one or more offering data fields. The communications server apparatus 202 may generate, for or in the one or more subscription data fields, the subscription data 241, and, for or in the one or more offering data fields, the offering data 242, 244, 246, the additional offering data, and the offering data for each additional group member.

In the context of various embodiments, the one or more data records 240 may be associated with or accessible by the communications server apparatus 202. The one or more data records 240 may be generated by the communications server apparatus 202. The one or more data records 240 may be modified or updated by the communications server apparatus 202. The one or more data records 240 may be stored at the communications server apparatus 202, e.g., in the memory 218.

FIG. 2C shows a schematic block diagram illustrating architecture components of the communications server apparatus 202. That is, the communications server apparatus 202 may further include a data generating module 260 to generate the subscription data 241, the plurality of offering data 242, 244, 246, the token data 242a, 244a, 246a, the additional offering data, the offering data for each additional group member and the token data for each additional group member. The communications server apparatus 202 may further include a communication module 262 to communicate the subscription plan to the (user) communications device.

In the context of various embodiments, the communications server apparatus 202 may be a single server, or have the functionality performed by the communications server apparatus 202 distributed across multiple server components.

FIG. 2D shows a flow chart 250 illustrating a method for managing a subscription plan for a plurality of offering categories.

In response to receiving subscription request data having at least one data field indicative of a request by a user for subscribing to the subscription plan for the plurality of offering categories, at 252, subscription data indicative of the subscription plan are generated in one or more data records, the subscription data including a plurality of offering data for a corresponding plurality of offering categories to be covered in the subscription plan, wherein, for each offering data, the offering data includes token data indicative of tokens associated with the corresponding offering category, the tokens being usable for offerings in the corresponding offering category, and, at 254, the subscription plan is communicated to a communications device of the user.

For the each offering data, the token data may include token number data indicative of a number of the tokens associated with the corresponding offering category.

For the each offering data, the token data includes time data indicative of one or more time periods that the tokens are available.

At 252, the token data for the plurality of offering categories may be generated based on output data generated by one or more machine learning (ML) models trained using user historical data.

In response to receiving user input data corresponding to the tokens, at 252, the token data may be modified in accordance with the user input data.

In response to receiving add request data indicative of a request by the user to include an additional offering category in the subscription plan, at 252, additional offering data for the additional offering category may be generated, the additional offering data including additional token data indicative of tokens associated with the additional offering category.

In response to receiving group request data indicative of a request by the user to include a group having the user as a group member and one or more additional group members in the subscription plan, at 252, for each additional group member, a plurality of offering data for a corresponding plurality of offering categories to be covered in the subscription plan may be generated, wherein, for each offering data, the offering data may include token data indicative of tokens associated with the corresponding offering category.

For the each offering data for the each additional group member, the token data may include token number data indicative of a number of the tokens associated with the corresponding offering category.

For the each offering data for the each additional group member, the token data may include time data indicative of one or more time periods that the tokens are available.

At 252, the token data for the plurality of offering categories for the each additional group member may be generated based on output data generated by one or more machine learning (ML) models trained using user historical data.

In response to receiving additional user input data corresponding to the tokens for the each additional group member, at 252, the token data for the each additional group member may be modified in accordance with the additional user input data.

In response to receiving confirmation data having at least one data field indicative of a confirmation by the user to the subscription plan, the subscription data may be stored in a database.

It should be appreciated that description in the context of the communications server apparatus 202 may correspondingly be applicable in relation to the method as described in the context of the flow chart 250, and vice versa.

The method as described in the context of the flow chart 250 may be performed in a communications server apparatus (e.g., 202; FIG. 2A) for managing a subscription plan for a plurality of offering categories, under control of a processor of the communications server apparatus. The method may further include, executing under control of the processor, instructions stored in a memory of the communications server apparatus, operating a data generating module (e.g., 260, FIG. 2C) to generate the subscription data 241, the plurality of offering data 242, 244, 246, the token data 242a, 244a, 246a, the additional offering data, the offering data for each additional group member and the token data for each additional group member, and operating a communication module (e.g., 262, FIG. 2C) to communicate the subscription plan to the (user) communications device.

FIG. 2E shows a schematic block diagram illustrating a communications device 204 for managing a subscription plan for a plurality of offering categories. The communications device 204 includes a processor 228 and a memory 230, where the communications device 204 is configured, under control of the processor 228 to execute instructions in the memory 230 to, generate subscription request data indicative of a request by a user to subscribe to the subscription plan to cover the plurality of offering categories, and transmit (or communicate) the subscription request data to a communications server apparatus (e.g., 202, FIG. 2A) for processing. The processor 228 and the memory 230 may be coupled to each other (as represented by the line 229), e.g., physically coupled and/or electrically coupled. The processor 228 may be as described in the context of the processor 128 (FIG. 1) and/or the memory 230 may be as described in the context of the memory 130 (FIG. 1).

The communications device 204 may further generate user input data indicative of a change made by the user to one or more parameters of tokens associated with the plurality of offering categories, and transmit the user input data to the communications server apparatus for processing.

The communications device 204 may further generate add request data indicative of a request by the user to include an additional offering category in the subscription plan, and transmit the add request data to the communications server apparatus for processing.

The communications device 204 may further generate group request data indicative of a request by the user to include a group having the user as a group member and one or more additional group members in the subscription plan, and transmit the group request data to the communications server apparatus for processing.

FIG. 2F shows a flow chart 270 illustrating a method for managing a subscription plan for a plurality of offering categories. At 272, subscription request data indicative of a request by a user to subscribe to the subscription plan to cover the plurality of offering categories are generated. At 274, the subscription request data are transmitted to a communications server apparatus for processing.

User input data indicative of a change made by the user to one or more parameters of tokens associated with the plurality of offering categories may be generated, and the user input data may be transmitted to the communications server apparatus for processing.

Add request data indicative of a request by the user to include an additional offering category in the subscription plan may be generated, and the add request data may be transmitted to the communications server apparatus for processing.

Group request data indicative of a request by the user to include a group having the user as a group member and one or more additional group members in the subscription plan may be generated, and the group request data may be transmitted to the communications server apparatus for processing.

It should be appreciated that description in the context of the communications device 204 may correspondingly be applicable in relation to the method as described in the context of the flow chart 270, and vice versa.

The method as described in the context of the flow chart 270 may be performed in a communications device (e.g., 204; FIG. 2E) for managing a subscription plan for a plurality of offering categories, under control of a processor of the communications device.

There may also be provided a computer program product having instructions for implementing one or more of the methods described herein for managing a subscription plan for a plurality of offering categories.

There may also be provided a computer program having instructions for implementing one or more of the methods described herein for managing a subscription plan for a plurality of offering categories.

There may further be provided a non-transitory storage medium storing instructions, which, when executed by a processor, cause the processor to perform one or more of the methods described herein for managing a subscription plan for a plurality of offering categories.

In the context of various embodiments, a (user) communications device may include, but not limited to, a smart phone, tablet, handheld/portable communications device, desktop or laptop computer, terminal computer, etc.

In the context of various embodiments, an “App” or an “application” may be resident or installed on a (user) communications device and may include processor-executable instructions for execution on the device. As a non-limiting example, managing a subscription plan for a plurality of offering categories may be carried out by a user via an App.

Various embodiments may further provide a communications system for managing a subscription plan for a plurality of offering categories, having a communications server apparatus, at least one user communications device and communications network equipment operable for the communications server apparatus and the at least one user communications device to establish communication with each other therethrough, wherein the at least one user communications device includes a first processor and a first memory, the at least one user communications device being configured, under control of the first processor, to execute first instructions in the first memory to transmit, for receipt by the communications server apparatus for processing, subscription request data having at least one data field indicative of a request by a user for subscribing to the subscription plan for the plurality of offering categories, and, wherein the communications server apparatus includes a second processor and a second memory, the communications server apparatus being configured, under control of the second processor, to execute second instructions in the second memory to, in response to receiving data indicative of the subscription request data, generate, in one or more data records, subscription data indicative of the subscription plan, the subscription data including a plurality of offering data for a corresponding plurality of offering categories to be covered in the subscription plan, wherein, for each offering data, the offering data includes token data indicative of tokens associated with the corresponding offering category, the tokens being usable for offerings in the corresponding offering category, and communicate the subscription plan to the at least one user communications device.

Various embodiments or techniques will now be further described in detail by way of the following non-limiting examples.

### Dynamic Subscription Front End

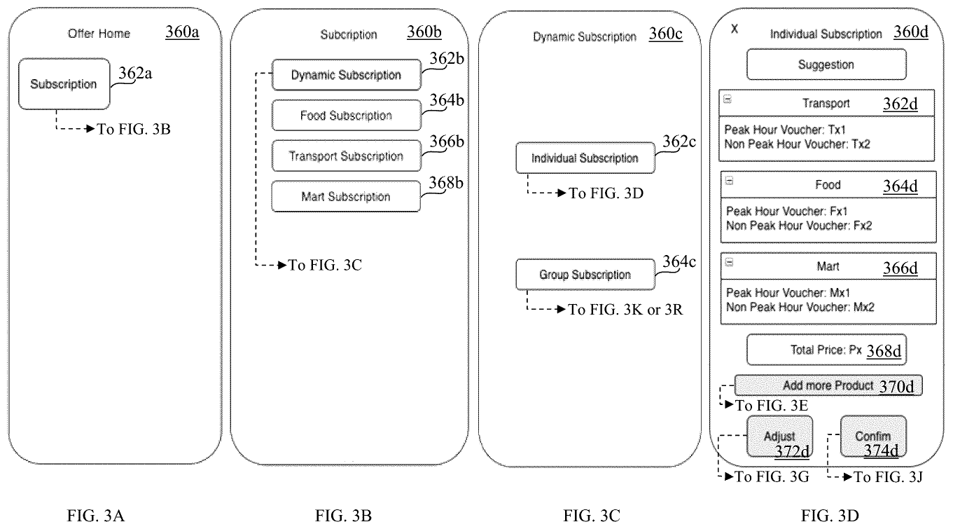

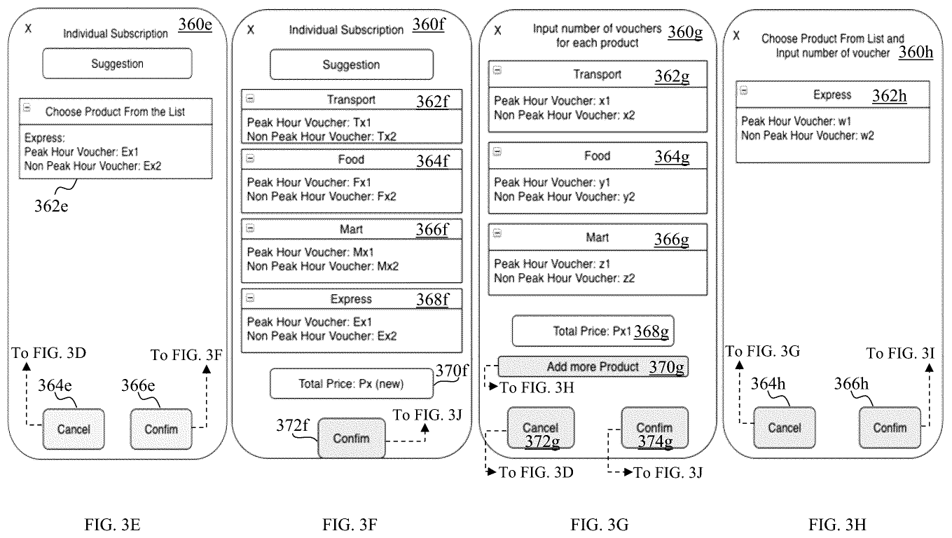

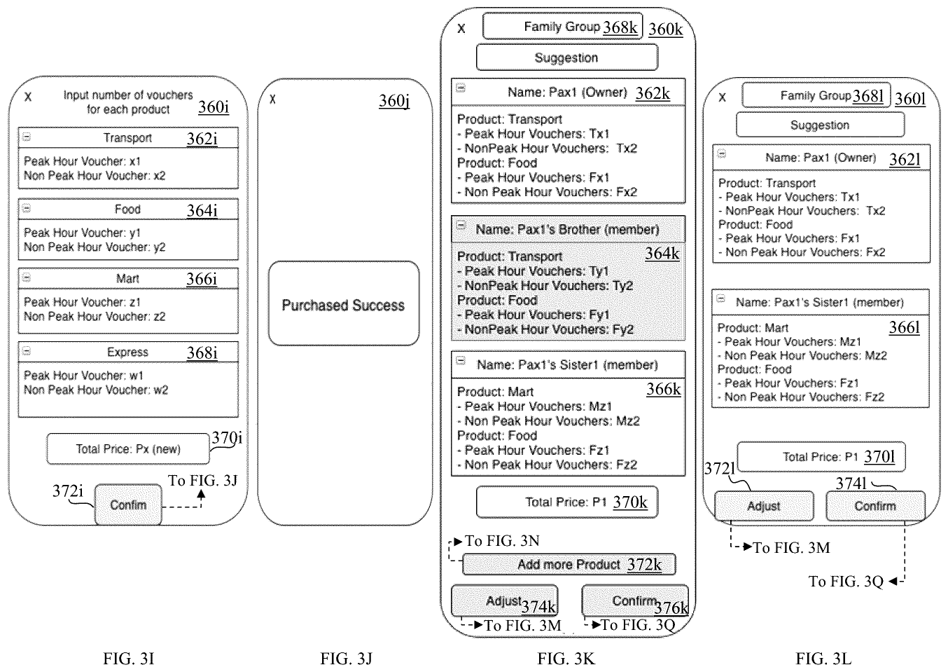

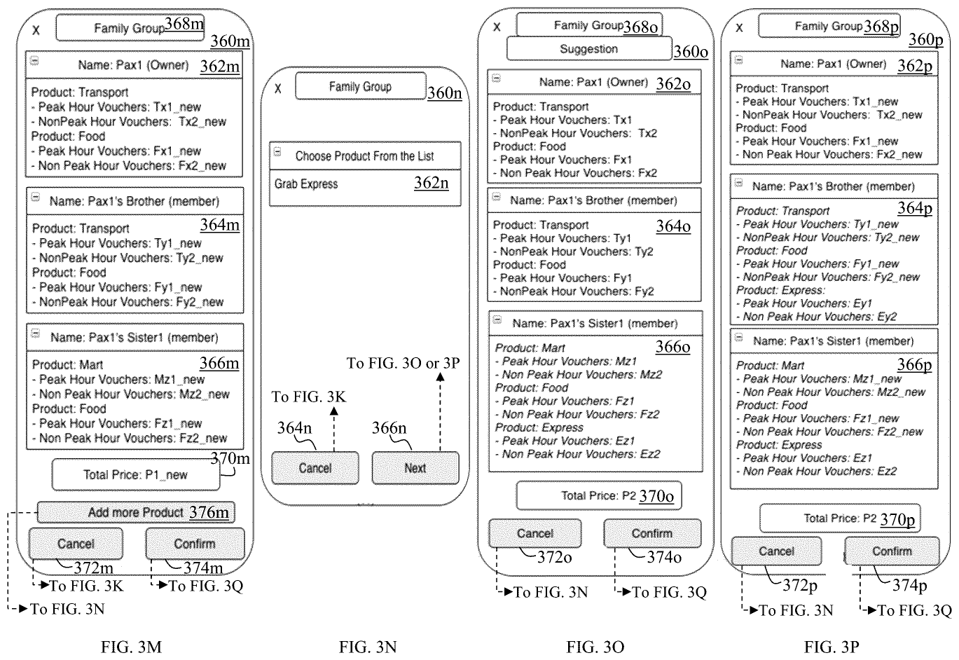

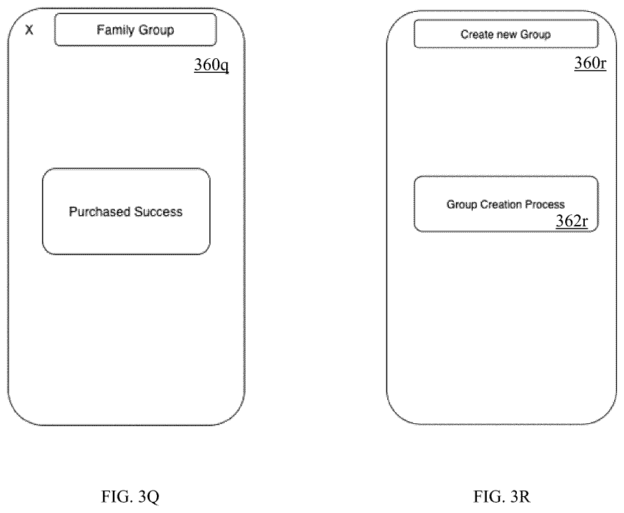

FIGS. 3A to 3R show an example of a process flow for a dynamic subscription front end (FE) of various embodiments. FIGS. 3A to 3R illustrates non-limiting examples of pages that users or account owners may progress through when subscribing or signing up for a subscription plan. The pages may be displayed or presented to a user on a user screen, for example, on a communications device of the user. In general, users can click on the “X” icon or button to close all sessions or the corresponding page.

FIG. 3A shows the Home Page or Offer Home Page 360a. When the user clicks on the “Subscription” tile or button 362a in the Offer Home Page 360a, the user will be taken to the Subscription page 360b shown in FIG. 3B.

A number of options 362b, 364b, 366b, 368b may be provided or shown on the Subscription page 360b. These may include, but not limited to, a “Dynamic Subscription” button (or tile) 362b, and one or more buttons (or tiles) 364, 366b, 368b, for subscriptions to individual or distinct offering categories, separately. As non-limiting examples, there may be provided a “Food Subscription” button 364b where the user can click on for signing up to subscription covering a food-related category with the corresponding services (e.g., ordering (which may include payment) and delivery of foods, etc.), a “Transport Subscription” button 366b where the user can click on for signing up to subscription covering a transport-related category with the corresponding services (e.g., rides, ride-hailing services, etc.) and a “Mart Subscription” button 368b where the user can click on for signing up to subscription covering a goods-related category with the corresponding services (e.g., on-demand goods ordering (which may include payment) and delivery service). Users can choose one or more of the desired options 364b, 366b, 368b, for subscribing to individual and respective subscription plans for the individual offering categories. Additionally or alternatively, the user can choose the “Dynamic Subscription” option 362b where the user can click on for signing up to a subscription plan covering a plurality of (distinct) offering categories collectively under one subscription plan, for example, food-related category, transport-related category and goods-related category, compared to signing up for separate individual subscriptions using the respective options 364b, 366b, 368b. When the user clicks on the “Dynamic Subscription” option 362b, the user will be taken to the Dynamic Subscription page 360c shown in FIG. 3C.

Two buttons or tiles 362c, 364c may be provided on the Dynamic Subscription page 360c. The “Individual Subscription” button 362c provides the option of allowing users to buy a dynamic subscription for themselves only, for example, an account owner signing up to a dynamic subscription plan for himself/herself only. Upon clicking the button 362c, the user (or account owner) will be taken to page 360d shown in FIG. 3D. The “Group Subscription” button 364c provides the option of allowing the user (as an account owner or group owner) to buy a dynamic subscription for all group members included or assigned to the group. When the user clicks on the button 364c, the user may be taken to page 360k shown in FIG. 3K, if there is already an existing group.

FIG. 3D shows the Individual Subscription page 360d. Different offering categories 362d, 364d, 366d under the subscription plan may be provided or suggested. It should be appreciated that more or less number of categories than the categories 362d, 364d, 366d may be provided. The number of tokens or vouchers for each category 362d, 364d, 366d may be suggested. The number of tokens or vouchers may be suggested for defined time periods, e.g., peak hours and/or non peak hours. Suggestions for the categories 362d, 364d, 366d and/or the number of vouchers for each category 362d, 364d, 366d may be provided based on one or more machine learning (ML) models.

In the context of various embodiments, each voucher may offer a certain amount of discount when it is applied to an offering. In other words, there may be a defined discount value associated with a voucher, which when applied to a certain service (e.g., ride-hailing service in the transport-related category), allows the user to enjoy a discounted cost or price for the ride.

As a non-limiting example, a user may apply or use a voucher as discount for delivery fee for food services (e.g., food ordering, food delivery, etc.), goods services (e.g., purchase and/or delivery of groceries, packaged goods/foods, household products, etc.), etc. As a further non-limiting example, a user may apply a voucher as discount on the total price (or fee) for logistics (e.g., delivery of documents, packages, parcels, goods, etc.), transport (e.g., ride-hailing services, ride-sharing services, etc.), etc.

In the context of various embodiments, as non-limiting examples, peak hours may be defined and split into 2 parts or periods: preferably, the morning peak hours from 11:00 am to 13:59 pm (inclusive), and the evening peak hours from 17:00 pm to 20:59 pm (inclusive). Any time outside of the above-mentioned hours may be defined as part of non peak hours. Nevertheless, it should be appreciated that the timings for peak hours and non-peak hours may be changed or adjusted accordingly or where suitable, e.g., based on the real business situation. Further, it should be appreciated that time periods may be defined in another form other than peak hours/non peak hours.

As non-limiting examples, rewards or benefits (e.g., discount values) associated with the vouchers may be the same for peak hour vouchers (i.e., vouchers applicable during peak hours) and non peak hour vouchers (i.e., vouchers applicable outside of peak hours). Nevertheless, it should be appreciated that differences in the offers or benefits between the peak hour vouchers and the non peak hour vouchers may be provided.

As a non-limiting example, a user may have to pay more (or equal) for peak hour vouchers when compared to the non peak hour vouchers. This may be defined based on the real business circumstance and/or the specific market. The price difference may be provided as a means to balance supply and demand, on the expectation that there will be greater demand during peak hours that may potentially lead to undersupply of the required services.

In the context of various embodiments, the input data for a machine learning model may include historical data of users, which, for example, may be obtained from users when they use the corresponding App to access or request for related services. Such input data or historical data may include, but not limited to, one or more of: new or existing subscriber, new or existing user, gross merchandise value (GMV), average order value, number of completed booking, number of vouchers, products that have been used, promo value (e.g., voucher or promotion discount value), promo booking, total revenue, total cost, subscription cost, subscription benefit, subscription duration, subscription type, subscription product partner, country, city, reward type, offer type, promo amount off, promo percentage off, promo percentage off cap amount, (administrator) point spend, order basket size, order/booking value, commission for merchant/driver.

In the context of various embodiments, the output data of a machine learning model may include, but not limited to, the number of vouchers in peak/non peak hour of each product and total price for all vouchers for each user. As a non-limiting example, for a user “abc”, the machine learning model may provide outputs including, but not limited to, 10 transport vouchers for peak hours (e.g., 11:00-13:59 and 17:00-20.59), 5 transport vouchers for non peak hours, 25 food vouchers for peak hours, 10 food vouchers for non peak hours, total price: 9.99$, and information that all vouchers are valid for 30 days from the issue date.

Referring back to FIG. 3D, suggestions of the categories 362d, 364d, 366d and the corresponding vouchers may be displayed or presented to the user to view on the current page 360d. The user may click on the “-” icon or button for a particular category 362d, 364d, 366d to remove the corresponding category 362d, 364d, 366d that the user may not want to use or be covered under the subscription plan. All the vouchers for the category 362d, 364d, 366d to be removed are also removed. The “Total Price: Px” section 368d shows the total price determined for the categories 362d, 364d, 366d and the corresponding vouchers presented on the page 360d.

On the Individual Subscription page 360d, there may be provided an “Add more product” tile or button 370d providing the user with the option of adding one or more categories that are not in the current selection (with the approach that the number of vouchers for the additional categories being suggested to the user by an ML model). Upon the user clicking on the button 370d, the user will be taken to page 360e shown in FIG. 3E. There may also be provided an “Adjust” tile or button 372d providing the user with the option of modifying the number of vouchers that the user wishes to buy in each offering category under the subscription plan. Upon the user clicking on the button 372d, the user will be taken to page 360g shown in FIG. 3G. Also provided on the Individual Subscription page 360d is a “Confirm” tile or button 374d which the user can click on to confirm the current selection. Clicking on the button 374d will take the user to page 360j shown in FIG. 3J.

FIG. 3E shows the “Additional Product” page 360e that allows the user to choose one or multiple categories 362e from a list, with suggestion from one or more ML models for the number of vouchers for peak hours and/or non peak hours. An auto suggested number of vouchers for a particular (new) category, as determined from a machine learning model, is provided at page 360e. If there are multiple categories available or presented on the page 360e, the user can click on the corresponding “-” icon or button to remove the particular category that the user does not wish to use or be covered under the subscription plan. A “Cancel” tile or button 364e may be provided to allow the user to cancel the current selection and return to the previous page 360d. A “Confirm” tile or button 366e may be provided to allow the user to confirm the current selection, which, upon the user clicking the button 366e, will bring the user to page 360f shown in FIG. 3F.

Page 360f shows the selected categories 362f, 364f, 366f, 368f and the corresponding vouchers, and the prices for the user to review before confirming to purchase. The user can click on the corresponding “-” icon or button to remove the particular category 362f, 364f, 366f, 368f and the corresponding vouchers that the user does not wish to use or be covered under the subscription plan. The “Total Price: Px(new)” section 370f shows the new total price determined for the selected categories 362f, 364f, 366f, 368f (after the user added and/or removed certain service(s)). A “Confirm” tile or button 372f may be provided to allow the user to confirm the current selection, and to purchase the dynamic subscription for the user. Clicking on the button 372f will take the user to page 360j shown in FIG. 3J.

FIG. 3G shows the “Manual adjustment product” page 360g which allows the user to modify the number of vouchers that the user wishes to buy, e.g., by keying in suitable numbers for the vouchers. The user can click on the corresponding “-” icon or button to remove the particular category 362g, 364g, 366g that the user does not wish to use or be covered under the subscription plan. The user may input or key in the number of vouchers for any one of the “Peak Hour Voucher” and the “Non Peak Hour Voucher” for any one of the categories 362g, 364g, 366g at the corresponding positions indicated as “x1”, “x2”, “y1”, “y2”, “z1”, “z2”, such that these parameters may be replaced by the desired numbers (example: x1=3, x2=4, y1=5, y2=6, z1=7, z2=8). The “Total Price: Px1” section 368g shows the new total price determined for the current selection of offering categories 362g, 364g, 366g.

On page 360g, there may be provided an “Add more product” tile or button 370g providing the user with the option of adding one or more categories that are not in the current selection. Upon the user clicking on the button 370g, the user will be taken to page 360h shown in FIG. 3H. A “Cancel” tile or button 372g may be provided to allow the user to cancel the current selection and return to the previous page 360d. A “Confirm” tile or button 374g may be provided to allow the user to confirm the current selection and purchase the selected categories 362g, 364g, 366g, which, upon the user clicking the button 374g, will bring the user to page 360j shown in FIG. 3J to confirm purchase success.

FIG. 3H shows the “Add more product” page 360h which allows the user to add one or more categories 362h, and manually select the number of vouchers (e.g., for peak and/or non peak hours) in each category 362h in the product list the user wishes to add. In contrast to the auto suggestion approach on page 360e, page 360h provides a manual input page, where users may input the number of vouchers they want to buy for a new category. The user may key in the number of vouchers for each new category 362h the user wants to add. The user may input or key in the number of vouchers for any one of the “Peak Hour Voucher” and the “Non Peak Hour Voucher” for each category 362h at the corresponding positions indicated as “w1”, “w2”, such that these parameters may be replaced by the desired numbers (example: w1=3, w2=4). The user may click on the corresponding “-” icon or button to remove the particular service 362h that the user does not wish to use or be covered under the subscription plan. A “Cancel” tile or button 364h may be provided to allow the user to cancel the current selection and return to the previous page 360g. A “Confirm” tile or button 366h may be provided to allow the user to confirm the selection of additional category(ies) 362h. Upon the user clicking the button 366h, the user will be taken to page 360i shown in FIG. 3I.

Page 360i shows the selected categories 362i, 364i, 366i, 368i and the corresponding vouchers, and the prices for the user to review before confirming to purchase. The user can click on the corresponding “-” icon or button to remove the particular category 362i, 364i, 366i, 368i and the corresponding vouchers that the user does not want or be covered under the subscription plan. The “Total Price: Px(new)” section 370i shows the new total price determined for the selected categories 362i, 364i, 366i, 368i (after the user added and/or removed certain category(ies). A “Confirm” tile or button 372i may be provided to allow the user to confirm the current selection, and to purchase the dynamic subscription for the user. Clicking on the button 372i will take the user to page 360j shown in FIG. 3J.

FIG. 3J shows a “Confirmation” page 360j to confirm the success of the user's purchase of the subscription plan.

Where a group has been created in advance, with group members defined in the group, a user or account owner clicking on the button 364c on the Dynamic Subscription page 360c will be taken to page 360k shown in FIG. 3K. Page 360k is the dynamic subscription page for the group which allows the account owner or group owner 362k to buy a subscription for the owner 362k and each of the other group members 364k, 366k in the group 368k (e.g., “Family Group”) which was previously created. While three group members 362k, 364, 366k are shown, it should be appreciated that there may be at least two group members, for example, two, three, four, five or any higher number of group members.

One or more suitable categories under the subscription plan may be provided or suggested for each group member 362k, 364k, 366k in the group 368k. Suitable number of vouchers for each category may be suggested for each member 362k, 364k, 366k. The number of vouchers may be suggested for peak hours and/or non peak hours. Suggestions for the categories and/or the number of vouchers for each service may be provided based on one or more ML models. The ML model may be trained using the historical data associated with users to calculate the number of corresponding vouchers to be provided for a particular user. Examples of the input data and the output data associated with the ML model are as described herein above.

Suggested categories and the corresponding vouchers may be displayed or presented on the current page 360k. The account owner 362k may click on the “-” icon or button that allows the owner 362k to remove one or more members 362k, 364k, 366k in the group 368k. Clicking on the “-” icon brings the owner 362k to page 360| shown in FIG. 3L. The “Total Price: P1” section 370k shows the total price determined for the categories and the corresponding vouchers for all group members 362k, 364k, 366k presented on the page 360k.

On page 360k, there may be provided an “Add more product” tile or button 372k allowing the group owner to add one or more categories that are not in the current selection. Upon the user clicking on the button 372k, the user will be taken to page 360n shown in FIG. 3N. There may also be provided an “Adjust” tile or button 374k allowing the group owner to modify one or more category(ies) and the corresponding vouchers manually for each member 362k, 364k, 366k. Upon the account owner clicking on the button 374k, the account owner will be taken to page 360m shown in FIG. 3M. Also provided on the page 360k is a “Confirm” tile or button 376k which the account owner can click on to confirm the current selection of categories, vouchers and members 362k, 364k, 366k to purchase a dynamic subscription. Clicking on the button 376k will take the user to page 360q shown in FIG. 3Q.

Page 360l of FIG. 3L displays the remaining members 362l, 366l in the group 368l along with the corresponding categories and vouchers. One or more ML models may be employed to suggest the categories and the number of vouchers for each member 362l, 366l. The categories and the corresponding vouchers (and numbers thereof) that are suggested and displayed on page 360l may be the same as those suggested and displayed on page 360k.

The “Total Price: P1” section 370l shows the new total price determined for the current selection. There may be provided an “Adjust” tile or button 372l allowing the group owner 362l to manually modify one or more category(ies) and the corresponding vouchers for each group member 362l, 366l. Upon the account owner 362l clicking on the button 372l, the account owner will be taken to page 360m shown in FIG. 3M. A “Confirm” tile or button 374| may be provided to allow the group owner 362l to confirm the current selection, and to purchase the dynamic subscription for the group 368l. Clicking on the button 374| will take the group owner 362l to page 360q shown in FIG. 3Q.

Page 360m of FIG. 3M allows the group owner 362m to modify the category(ies) and/or the number of corresponding vouchers for each member 362m, 364m, 366m of the group 368m. The group owner 362m may key in the number of vouchers for each category for each member 362m, 364m, 366m and/or change one or more categories for each member 362m, 364m, 366m. The account owner 362m may click on the “-” icon or button that allows the owner 362m to remove one or more other group members 364m, 366m. The “Total Price: P1_new” section 370m shows the new total price determined after the relevant modification has been made.

A “Cancel” tile or button 372m may be provided to allow the owner 362m to cancel the current selection. Upon the owner 362m clicking on the button 372m, the owner 362m will be taken to page 360k shown in FIG. 3K. A “Confirm” tile or button 374m may be provided, which the account owner 362m can click on to confirm the current selection of offering categories, vouchers and members 362m, 364m, 366m to purchase the subscription. Clicking on the button 374m will take the owner 362m to page 360q shown in FIG. 3Q. An “Add more product” tile or button 376m may be provided, allowing the group owner 362m to add one or more categories that are not in the current selection. Upon the owner 362m clicking on the button 376m, the owner 362m will be taken to page 360n shown in FIG. 3N.

On page 360n, the group owner may add one or more categories 362n from a service list. If there are multiple categories available or presented on the page 360n, the group owner may click on the corresponding “-” icon or button to remove the particular category that the group owner does not wish to use or be covered under the subscription plan. A “Cancel” tile or button 364n may be provided to allow the group owner to cancel the current selection. Upon the group owner clicking on the button 364n, the group owner will be taken to page 360k shown in FIG. 3K. A “Next” tile or button 366n may be provided to allow the group owner to confirm the category(ies) to be added to the subscription. If the previous step was an auto-suggestion from an ML model (i.e., page 360k), clicking on the button 366n takes the group owner to page 360o shown in FIG. 3O. If the previous step was a manual adjustment (i.e., page 360m), clicking on the button 366n takes the group owner to page 360p shown in FIG. 3P.

Page 360o of FIG. 3O shows the category(ies) and corresponding vouchers that may be assigned to each group member 362o, 364o, 366o of the group 368o based on one or more ML suggestion models, where the number of vouchers may be suggested for the additional/new categories. The account owner 362o may click on the “-” icon or button to remove one or more group members 362o, 364o, 366o, and, consequently the category(ies) and voucher(s) associated with the removed member(s). The “Total Price: P2” section 370o shows the total price determined for the current selection of categories and the corresponding vouchers for group members 362o, 364o, 366o. A “Cancel” tile or button 372o may be provided to allow the account owner 362o to cancel the current selection and go back to the previous page 360n. A “Confirm” tile or button 374o may be provided, which the account owner 362o may click on to confirm the current selection of categories, vouchers and members 362o, 364o, 366o to purchase the subscription. Clicking on the button 374o will take the owner 362o to page 360q shown in FIG. 3Q.

On page 360p of FIG. 3P, the group owner 362p may manually key in the number of vouchers corresponding to one or more new or added categories for each member 362p, 364p, 366p in the group 368p. The account owner 362p may click on the “-” icon or button to remove one or more group members 362p, 364p, 366p, and, consequently the category(ies) and voucher(s) associated with the removed member(s). The “Total Price: P2” section 370p shows the total price determined for the current selection of categories and the corresponding vouchers. A “Cancel” tile or button 372p may be provided to allow the account owner 362p to cancel the current selection and go back to the previous page 360n. A “Confirm” tile or button 374p may be provided, which the account owner 362p may click on to confirm the current selection of categories and vouchers to purchase the subscription. Clicking on the button 374p will take the owner 362p to page 360q shown in FIG. 3Q.

FIG. 3Q shows a “Confirmation” page 360q to confirm that the dynamic subscription plan for the group has been purchased successfully.

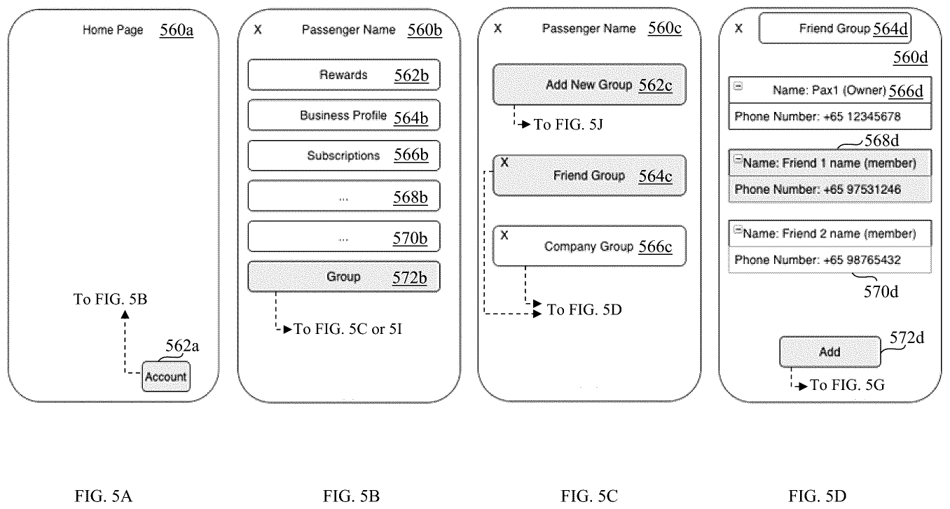

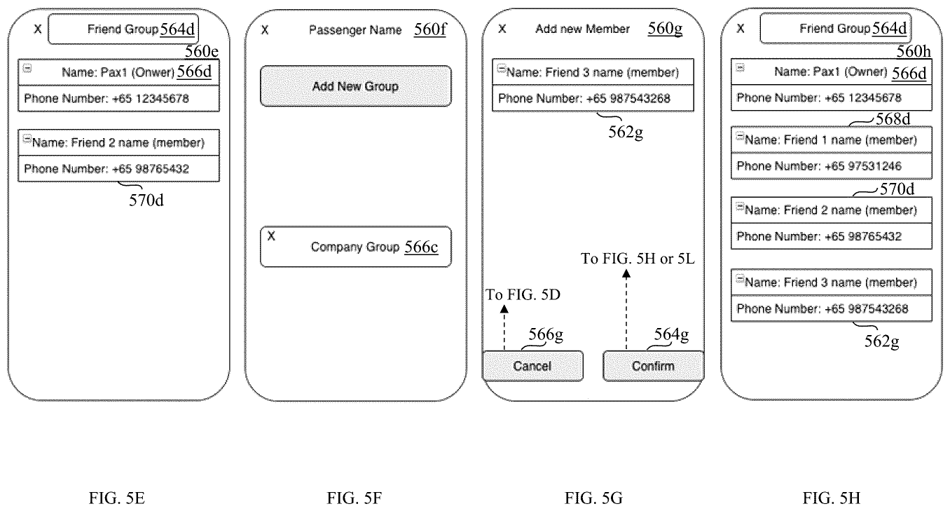

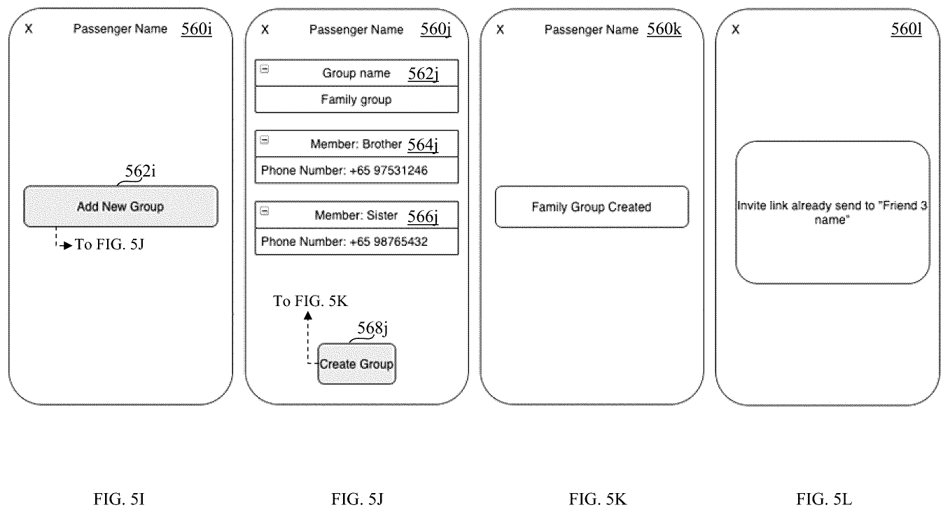

Referring to FIG. 3C, where a particular group has not been created yet, a user or account owner clicking on the button 364c on the Dynamic Subscription page 360c will be taken to page 360r shown in FIG. 3R. Page 360r is a “Create new group” page 360r which allows the account owner to create one or more new groups. A “Group Creation Process” tile or button 362r may be provided, which upon clicking, allows the account owner to create a new group, whether or not a different group already exists. The account owner may provide a name to the new group and define one or more members to be included in the new group. As non-limiting examples, the group creation process may be as described further below in relation to FIGS. 5A to 5L.

### Dynamic Subscription Back End

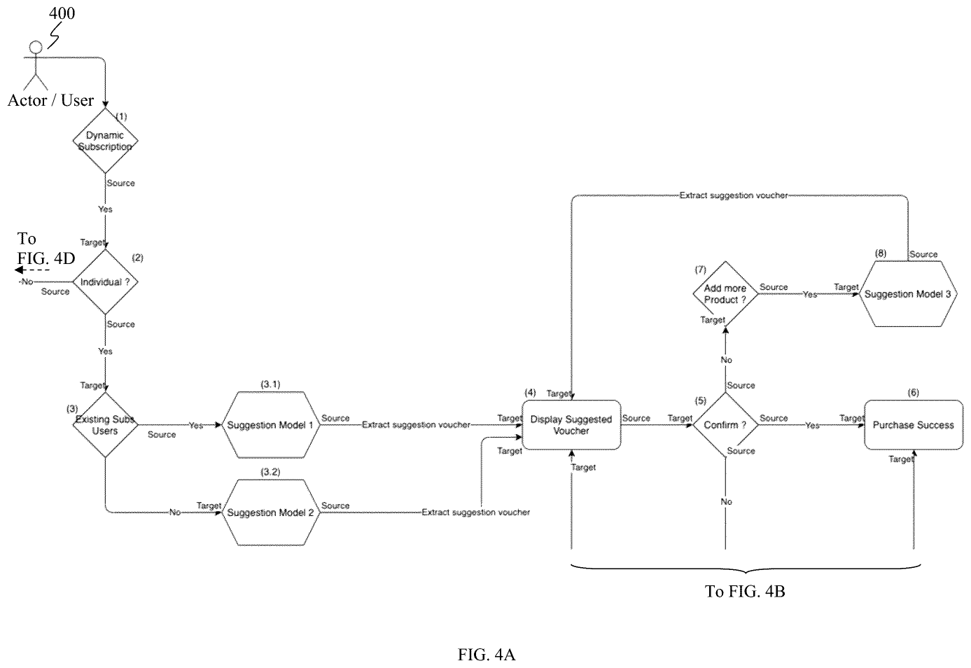

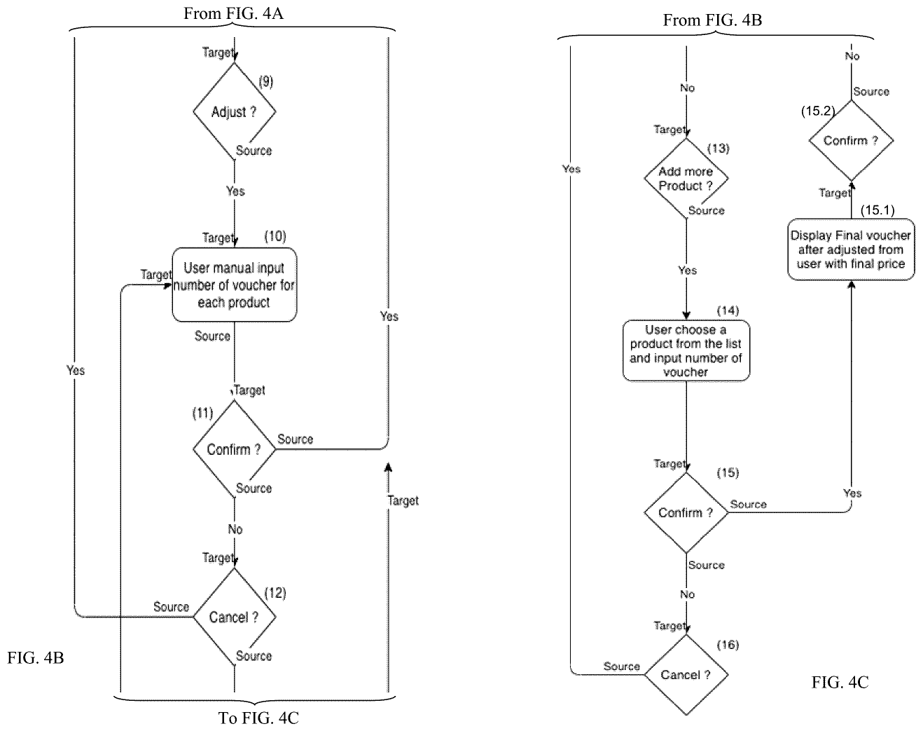

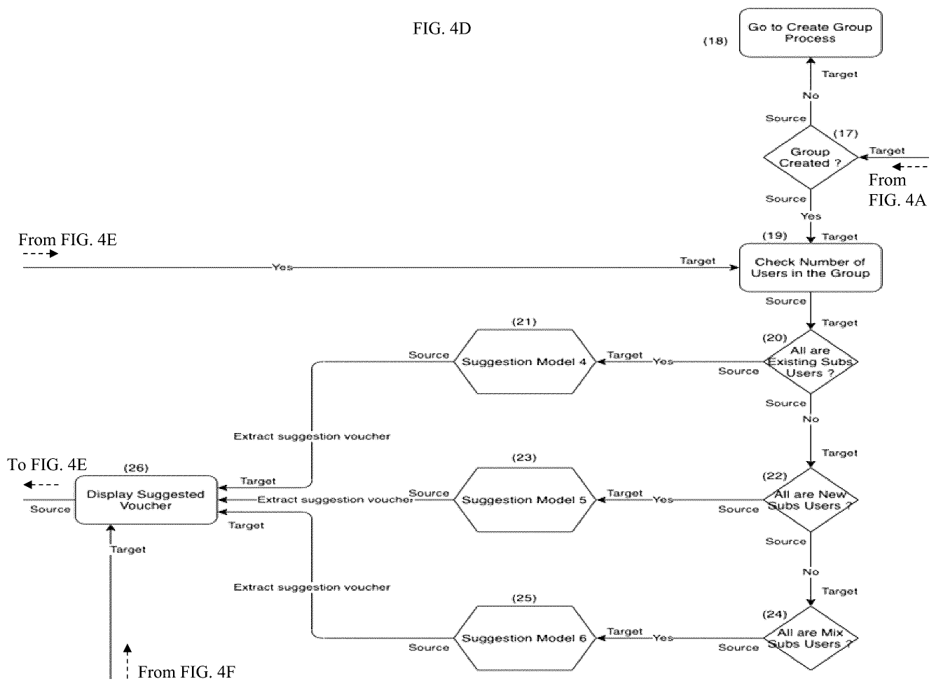

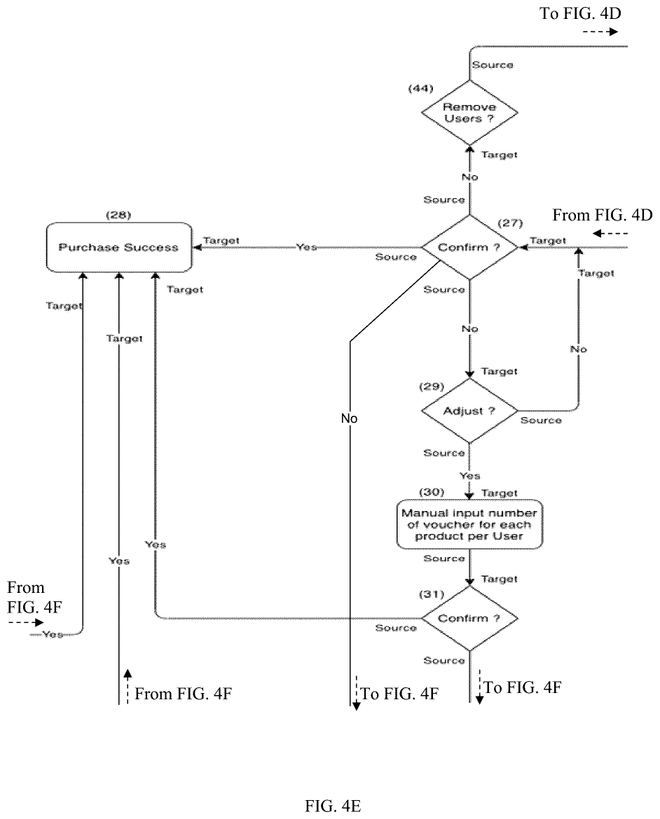

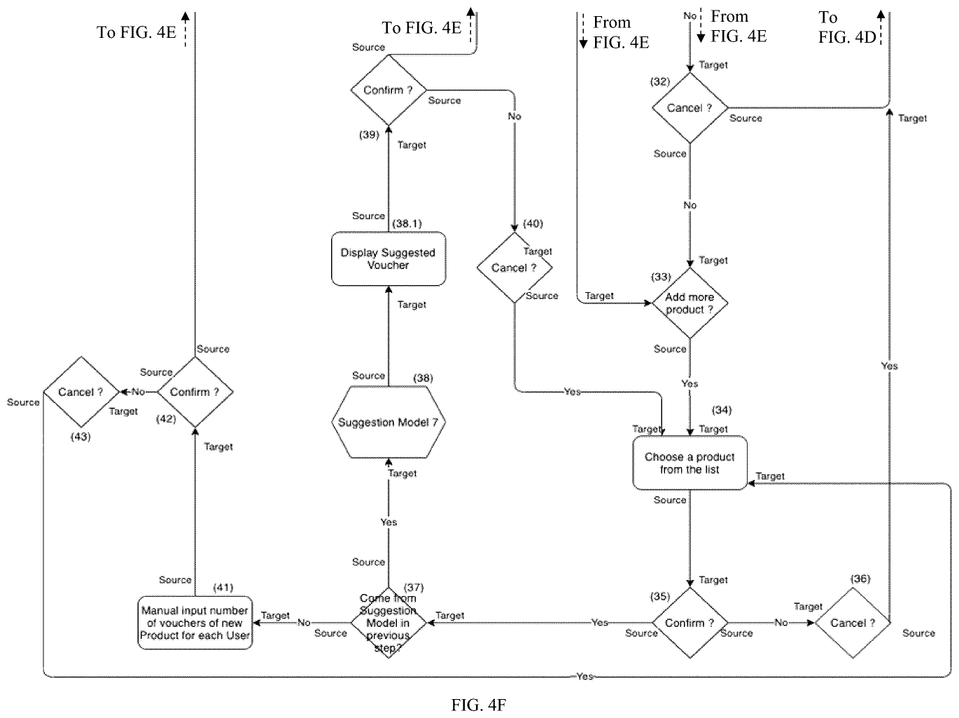

FIGS. 4A to 4F show an example of a process flow for a dynamic subscription back end (BE) of various embodiments. In FIGS. 4A to 4F, the term “Source” refers to the output of the previous step, while the term “Target” refers to the input of the next step. Description is provided below in relation to FIGS. 4A to 4F with reference to FIGS. 3A to 3R.
At BE step (1) shown in FIG. 4A, when a user 400 clicks on the “Dynamic Subscription” button 362b on the front end (FE) (e.g., user side) (see FIG. 3B), the back end (BE) (e.g., server side) will check if the user 400 already clicked on the “Dynamic Subscription” button 362b. If yes, the process then proceeds to BE step (2) and FE page 360c (FIG. 3C).
At BE step (2) shown in FIG. 4A, when the user 400 clicks on the “Individual Subscription” button 362c on FE page 360c, the BE will check if the user 400 already clicked on the button 362c. If yes, the process then proceeds to BE step (3).
At BE step (3), if the current user 400 bought a subscription in the past, BE will retrieve or collect the user historical data for this user 400 and input to “Suggestion Model 1” at BE step (3.1). The user historical data include historical data for the user 400 regardless of whether the historical data are data related to past subscription(s) or outside of subscription(s), in order to capture all transactional and engagement data. If the current user 400 has not bought a subscription before, then BE will collect user historical data for this user 400 and input to “Suggestion Model 2” at BE step (3.2). Such historical data include data for the user 400 outside of subscriptions, e.g., where the user used a service/product without subscription.
At BE step (3.1), the “Suggestion Model 1” uses the user historical data and their historical subscription(s) when the user 400 previously used the corresponding App as input data to the model. Based on the real business situation, more or less data may be collected. The input data may include, but not limited to, one or more of:
Number of subscription(s) that has been bought by this user in the past;
Price for past subscription(s);
Number of vouchers that has been used in the past;
GMV;
Revenue;
Total benefit for past subscription(s);
Total cost;
Number of completed booking for each category use subscription/non subscription (e.g., use of services in each offering category within a subscription plan or outside a subscription plan) and peak/non peak hours;
Area, location;
Merchant.

The output data from the “Suggestion Model 1” are sent to BE step (4), which may include, but not limited to, one or more of:
The number of vouchers for each offering category in peak and non peak hour;
Total price for subscription.
At BE step (3.2), the “Suggestion Model 2” uses the user historical data (outside of subscriptions) when the user 400 previously used the corresponding App as input data to the model. Based on the real business situation, more or less data may be collected. The input data may include, but not limited to, one or more of:
GMV;
Revenue;
Number of completed booking for each category use promo/non promo (i.e., use of services in each offering category during a promotion or outside a promotion) and peak/non peak hour;
Total cost;
Area, location;
Merchant.

The output data from the “Suggestion Model 2” are sent to BE step (4), which may include, but not limited to, one or more of:
The number of vouchers for each offering category in peak and non peak hour;
Total price for subscription.
At BE step (4), the BE (e.g., server) sends the results (including suggested vouchers) to be presented or displayed to the user 400 on page 360d (FIG. 3D), and waits for confirmation from the user at BE step (5).
At BE step (5), the BE (e.g., server) checks for confirmation or other action by the user 400. If the user 400 clicks the “Confirm” button 374d on page 360d, then vouchers with offering category(ies) for peak/non peak hours are issued. The process then proceeds to BE step (6) and FE page 360j (FIG. 3J). If the user 400 does not click the “Confirm” button 374d, then check if the user 400 clicks the “Add More Product” button 370d (if yes, proceed to BE step (7)) or the “Adjust” button 372d (if yes, proceed to BE step (9)).
At BE step (6), the BE confirms the purchase from the user 400 and issue vouchers with category(ies) for peak/non peak hours to the user 400, and then sends to FE page 360j (FIG. 3J) and the process is completed.
At BE step (7), the BE checks whether the user 400 has clicked on the “Add More Product” button 370d on page 360d. If yes, the process proceeds to BE step (8) with the “Suggestion Model 3”.
At BE step (8) shown in FIG. 4A, the “Suggestion Model 3” uses the user historical data of the user combined with other user historical data (of other users) in the same segment or cluster to provide suggestion on additional/new offering category(ies) and the number of vouchers in peak and non peak hours for that new/addition category(ies). This helps to understand user's behaviour and make recommendations based also on other users' transaction patterns. If there is segmentation (clustering), then identify users in similar clusters may be identified based on different user features, e.g., transactional, engagement, behavioural, etc. Output from the “Suggestion Model 3” is sent to BE step (4), which may include, but not limited to, one or more of:
The number of vouchers for each category in peak and non peak hour;
Total price for subscription.
At BE step (9) shown in FIG. 4B, the BE checks whether the user 400 has clicked on the “Adjust” button 372d on page 360d. If yes, the process proceeds to BE step (10).
At BE step (10), the BE (e.g., server) loads default suggestion number and receives manual adjustment from the user 400 on page 360g (FIG. 3G) and waits for confirmation from user the user at BE step (11).
At BE step (11), the BE checks for confirmation from the user 400. If the user 400 clicks the “Confirm” button 374g on page 360g, then vouchers with category(ies) for peak/non peak hours are issued to the user 400. The process then proceeds to BE step (6) and FE page 360j (FIG. 3J). If the user 400 does not click the “Confirm” button 374g, the process proceeds to BE step (12).
At BE step (12), the BE checks for cancellation from the user 400. If the user 400 clicks the “Cancel” button 372g on page 360g, the BE cancels all changes made by the user and the process proceeds to BE step (4) and page 360d (FIG. 3D). If the user 400 does not click the “Cancel” button 372g, the process proceeds to BE step (13).
At BE step (13) shown in FIG. 4C, the BE checks whether the user 400 has clicked the “Add More Product” button 370g on page 360g. If yes, the process proceeds to BE step (14).
At BE step (14), the BE sends, to page 360h (FIG. 3H), a list of offering category(ies) that can be added. The BE then receives the number of vouchers inputted by the user 400 for a particular category in peak and non peak hours on page 360h. The BE then waits for confirmation from the user at BE step (15).
At BE step (15), the BE checks for confirmation from the user 400. If the user 400 clicks the “Confirm” button 366h on page 360h, then vouchers with category(ies) for peak/non peak hours are issued to the user 400. The process then proceeds to BE step (15.1) and FE page 360i (FIG. 3I). If the user 400 does not click the “Confirm” button 366h, the process proceeds to BE step (16).
At BE step (15.1), the BE calculates the total price for the final vouchers for all categories included in the subscription and sends the result to page 360i and then waits for confirmation from the user at BE step (15.2).
At BE step (15.2), the BE checks for confirmation from the user 400. If the user 400 clicks the “Confirm” button 372i on page 360i, then vouchers are issued and the result is sent to the user 400, with the process proceeding to BE step (6) and page 360j (FIG. 3J).
At BE step (16), the BE checks for cancellation from the user 400. If the user 400 clicks the “Cancel” button 364h on page 360h, the BE cancels all changes made by the user for the new category(ies) and vouchers and the process proceeds to BE step (10) and page 360g (FIG. 3G).
At BE step (2) shown in FIG. 4A, when the user 400 clicks on the “Group Subscription” button 364c on FE page 360c, the process proceeds to BE step (17), where the BE checks whether the user 400 has created any group before. If no group has been previously created, the process proceeds to BE step (18) and FE page 360r (FIG. 3R) for group creation. If the user 400 already created a group, the process proceeds to BE step (19).
At BE step (19) shown in FIG. 4D, the BE calculates the number of group members in the group (including user 400 as the account owner or group owner) and collects their past subscriptions. The process then proceeds to BE step (20).
At BE step (20), the BE checks the members whether they are existing subscription users. If all members in the group are existing subscription users, then the process proceeds to BE step (21) with the “Suggestion Model 4”. If all members in the group are not existing subscription users, then the process proceeds to BE step (22).
At BE step (21), the “Suggestion Model 4” collects or retrieves all historical data from these members in the group with their past subscription(s) on the corresponding App as input data to the “Suggestion Model 4”. The “Suggestion Model 4” then provides, as output, suggestions of the number of voucher/category/peak hour/non peak hour that may be issued to each member in the group with the total price. The BE (e.g., server) sends the results (including suggested vouchers) to BE step (26) to be presented or displayed to the user 400.
At BE step (22) relating to checking new subscription users, if all members in the group are new subscription users (meaning that the users have never bought any subscription before, the process proceeds to BE step (23) with the “Suggestion Model 5”. If all members in the group are not new subscription users, then the process proceeds to BE step (24).
At BE step (23), the “Suggestion Model 5” collects or retrieves all historical data from these members in the group with promo so as to understand user patterns based on promo or voucher transactions that they used in the past on the corresponding App as input data to the model, which then provides the suggested number of voucher/category/peak hour/non peak hour that may be issued to each member in the group with the total price as output. The BE (e.g., server) sends the results (including suggested vouchers) to BE step (26) to be presented or displayed to the user 400.
At BE step (24) relating to checking mix of subscription users, if all members in the group are a mix of existing subscription users and new subscription users, then the process proceeds to BE step (25) with the “Suggestion Model 6”.
At BE step (25), the “Suggestion Model 6” collects or retrieves all historical data from respective members in the group with their subscription and promo that they used in the past on the corresponding App as input data to the model, which then suggest the number of voucher/category/peak hour/non peak hour to be issued to each member in the group with total price as output. The BE (e.g., server) sends the results (including suggested vouchers) to BE step (26) to be presented or displayed to the user 400.
At BE step (26), results are received from the respective Suggestion Models and the results are sent to page 360k (FIG. 3K). The process waits for confirmation from the user 400 at BE step (27).
At BE step (27) shown in FIG. 4E, the BE checks for confirmation from the user 400. If the user 400 clicks the “Confirm” button 376k on page 360k, then vouchers with category(ies) for peak/non peak hours are issued to each member in the group, and the process proceeds to BE step (26) and page 360q (FIG. 3Q). In the event that the user 400 does not click the “Confirm” button 376k, if the user 400 removes one member from the group by clicking on the tile (-) of that member, then the process proceeds to BE step (44), or if the user 400 clicks on the “Adjust” button 374k (FIG. 3K), then the process proceeds to BE step (29) and page 360m (FIG. 3M), or if the user 400 clicks on the “Add more product” button 372k, then the process proceeds to BE step (33) and page 360n (FIG. 3N).
At BE step (28), the BE confirms the purchase from the user 400 and issue vouchers to each member in the group, and then sends to FE page 360q (FIG. 3Q) and the process is completed.
At BE step (29), if the user 400 clicks on the “Adjust” button 374k (FIG. 3K), then the process proceeds to BE step (30) and page 360m (FIG. 3M).
At BE step (30), the BE (e.g., server) loads default suggestion number and receives manual adjustment from the user 400 on page 360m (FIG. 3M) and waits for confirmation from the user 400 at BE step (31).
At BE step (31), the BE checks for confirmation from the user 400. If the user clicks on the “Confirm” button 374m (FIG. 3M), then vouchers with category(ies) for peak/non peak hours are issued to each member in the group, and the process proceeds to BE step (28) and page 360q (FIG. 3Q). If the user 400 does not click on the “Confirm” button 374m, then the process proceeds to BE step (32).
At BE step (32) shown in FIG. 4F, the BE checks for cancellation from the user 400. If the user clicks on the “Cancel” button 372m, then the BE cancels all changes made by the user and the process proceeds to BE step (26) and page 360k (FIG. 3K). If the user does not click on the “Cancel” button 372m, then the process proceeds to BE step (33).
At BE step (33) relating to checking of adding of offering category(ies) by the user 400, if the user clicks on the “Add more Product” button 376m on page 360m, the process proceeds to BE step (34).
At BE step (34), the BE sends a list of available category(ies) for the user 400, which is displayed on page 360n (FIG. 3N), and waits for user's confirmation at BE step (35).
At BE step (35), the BE checks for confirmation from the user 400. If the user clicks on the “Next” button 366n (FIG. 3N), equivalent to “Confirmation”, the category(ies) is selected and the process proceeds to BE step (37). If the user does not click on the “Next” button 366n, then the process proceeds to BE step (36).
At BE step (36), the BE checks for cancellation from the user 400. If the user 400 clicks on the “Cancel” button 364n (FIG. 3N), the BE cancels all selections and changes by the user 400, and the process goes back to BE step (26) and page 360k (FIG. 3K).
At BE step (37) relating to checking user flow, the BE checks that, if the user 400 is using manual adjustment flow where the process goes through BE steps (29, 30, 31, 32, 33, 34), then the process proceeds to BE step (41), and, if the user 400 is using suggestion flow where the process goes through BE steps (27, 33), then the process proceeds to BE step (38) with the “Suggestion Model 7”.
At BE step (38), the “Suggestion Model 7” uses the historical data of the user 400 combined with other user historical data (e.g., historical data of all other users, including the group member(s) and users outside of the group) in the same segment (or cluster) to provide suggestions on additional/new category(ies) and the number of vouchers in peak and non peak hours for the new/addition category(ies) for each member in the group. Output (including suggested vouchers) from the “Suggestion Model 7” is sent to BE step (38.1) to be presented or displayed to the user 400. The output from the “Suggestion Model 7” may include the number of vouchers for each category in peak and non peak hours for each member in the group, and the total price for the subscription.
At BE step (38.1), result is sent to page 360p (FIG. 3P), and the BE waits for confirmation from the user 400 at BE step (39).
At BE step (39), the BE checks for confirmation from the user 400. If the user clicks on the “Confirm” button 374p (FIG. 3P), then vouchers with category(ies) for peak/non peak hours are issued to each member in the group. The process then proceeds to BE step (28) and page 360q (FIG. 3Q). If the user 400 does not click the “Confirm” button 374p, the process proceeds to BE step (40).
At BE step (40), the BE checks for cancellation from the user 400. If the user 400 clicks on the “Cancel” button 372p (FIG. 3P), the BE cancels all changes for the new/additional category(ies), and the process goes to BE step (34) and page 360n (FIG. 3N).
At BE step (41), the user 400 is allowed to manually input the number of voucher(s) for new category(ies) of each group member for peak and non peak hours on page 360o (FIG. 3O). The BE receives and updates the manual inputted number(s) from the user 400 and waits for confirmation at BE step (42).
At BE step (42), the BE checks for confirmation from the user 400. If the user clicks on the “Confirm” button 374o (FIG. 3O), then vouchers with category(ies) for peak/non peak hours are issued to each group member. The process then proceeds to BE step (28) and page 360q (FIG. 3Q). If the user 400 does not click the “Confirm” button 374o, the process proceeds to BE step (43).
At BE step (43), the BE checks for cancellation from the user 400. If the user 400 clicks on the “Cancel” button 372o (FIG. 3O), the BE cancels all changes for the new/additional category(ies), and the process goes back to BE step (34) and page 360n (FIG. 3N).

In the context of various embodiments, one or more or each of the Suggestion Models 1, 2, 3, 4, 5, 6 and 7 described above may come up with or determine an optimal number of vouchers and/or an optimal price with a pricing model technique. One or more or each of the Suggestion Models 1, 2, 3, 4, 5, 6 and 7 may include a machine learning (ML) modelling technique that may include, but not limited to, XGBoost, and Neural Networks.

### Group Management Front End

FIGS. 5A to 5L show an example of a process flow for a group management front end of various embodiments. FIGS. 5A to 5L illustrate non-limiting examples of pages that users or account owners may progress through when creating a group for a subscription plan.

FIG. 5A shows the “Home Page” 560a. The group owner may click on the “Account” button 562a, as the current step, to go to account management. The “Home Page” 560a, may, for example, be presented or displayed to the group owner in the corresponding App that the group owner uses to create a group or sign up to a (dynamic) subscription plan. Clicking on the button 562a takes the owner to page 560b shown in FIG. 5B.

FIG. 5B shows the “Account” page 560b. A plurality of buttons 562b, 564b, 566b, 568b, 570b, 572b may be provided for various options that the group owner may access. There is a “Group” button 572b for the group owner to click to access the corresponding information. If the group owner has already previously created at least one group, clicking on the button 572b takes the group owner to page page 560c shown in FIG. 5C for group management. If the group owner has not previously created at least one group, clicking on the button 572b takes the group owner to page 560i shown in FIG. 5I.

Page 560c of FIG. 5C lists all the current groups 564c, 566c that the user (account owner or group owner) belongs to. As non-limiting examples, the user may belong to a “Friend Group” 564c and a “Company Group” 566c that have previously been created. There may be provided an “Add New Group” button 562c for the user to create one or more new groups. The user may click on one group, e.g., one of the “Friend Group” 564c and the “Company Group” 566c, to see all the group members inside the group. The user may then be taken to page 560d of FIG. 5D listing the corresponding group members and the detail or identifying information of the members, including their corresponding phone numbers. As a non-limiting example, page 560d lists the group members 566d, 568d, 570d of the “Friend Group” 564d upon the user or account owner 566d clicking on the “Friend Group” button 564c. Apart from the owner 566d, as an example, there are two other members 568d, 570d in the “Friend Group 564d. The account owner 566d may click on the “-” icon or button that allows the owner 566d to remove one or more members (other than the owner 566d) 568d, 570d in the group 564d. The account owner 566d may then be taken to page 560e shown in FIG. 5E, which shows a list of all the remaining members 566d, 570d in the group 564d after the member removal in the previous step. As a non-limiting example, the member 568d has been removed.

On page 560d of FIG. 5D, an “Add” button 572d may be provided for the group owner 566d to add one or more members to the corresponding group 564d. Upon clicking the button 572d, the user 566d is taken to page 560g (FIG. 5G).

Referring back to page 560c of FIG. 5C, upon the user clicking on the “Add New Group” button 562c to create a new group, the user is taken to page 560j (FIG. 5J). On page 560c, the user can also click on the “X” icon or button of a corresponding group that has been previously created to remove the group. Doing so brings the user to page 560f (FIG. 5F), which lists the remaining group(s) 566c that the group owner belongs to after the removal in the previous step. As a non-limiting example, the “Friend Group” 564c has been removed.

On page 560g of FIG. 5G, the group owner may add one or more new members 562g by inputting or keying in the identifying information of the member(s) to be added, for example, the member's name or identity, and a phone number associated with the member. If the new member 562g to be added is an existing user in the same system or platform as used by the owner to create the group or sign up for a (dynamic) subscription plan (e.g., an existing user of the same corresponding App used by the group owner for the system or platform for the subscription plan), the group owner may click on the “Confirm” button 564g to add the new member 562g, which takes the group owner to page 560h shown in FIG. 5H listing all current members 566d, 568d, 570d, 562g of the group 564d. A “Cancel” button 566g may be provided on page 560g for the group owner to cancel the step and go back to the previous page 560d of FIG. 5D.

If the new member 562g to be added is not an existing user in the same system or platform as used by the owner to create the group or sign up for a (dynamic) subscription plan (e.g., not an existing user of the same corresponding App used by the group owner for the system or platform for the subscription plan), the new member 562g cannot be added. Instead, upon the owner clicking on the “Confirm” button 564g, an invite link is sent to the new member 562g and the group owner is taken to page 560l of FIG. 5L.

As described above, if there is no existing group, clicking on the button 572b on page 560b takes the group owner to page 560i shown in FIG. 5I. An “Add New Group” button 562i may be provided for the group owner to click to create a group. Clicking on the button 562i takes the account owner to page 560j shown in FIG. 5J.

On page 560j, the group owner may create a group by inputting or keying in the group information for the group, e.g., defining the name (“Group Name”) of the group 562j. As a non-limiting example, the group is a “Family Group” 562j. The group owner may also add one or more group members (other than the account or group owner) 564j, 566j by inputting or keying in the identifying information of the member(s) to be added, for example, the member's name or identity, and a phone number associated with the member. If a new member to be added is not an existing user in the same system or platform as used by the owner to create the group or sign up for a (dynamic) subscription plan (e.g., not an existing user of the same corresponding App used by the group owner), the group owner would not be able to add such member to the group 562j. A “Create Group” button 568j may be provided on page 560j for the group owner to create the group 562j. Upon clicking on the button 568j, the group owner is taken to page 560k shown in FIG. 5K.

FIG. 5K shows a “Confirmation” page 560k to confirm that the group has been created.

It should be appreciated that, at every step, the user or account owner (or group owner) can click on the “X” icon or button to cancel the corresponding page or everything, and return to the Account page 560b of FIG. 5B.

### Group Management Back End

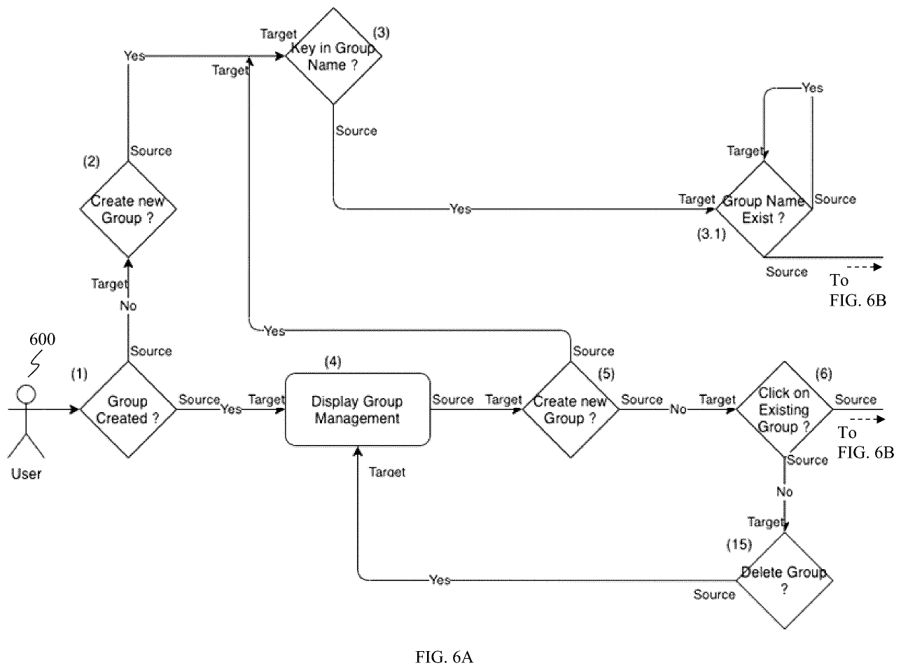

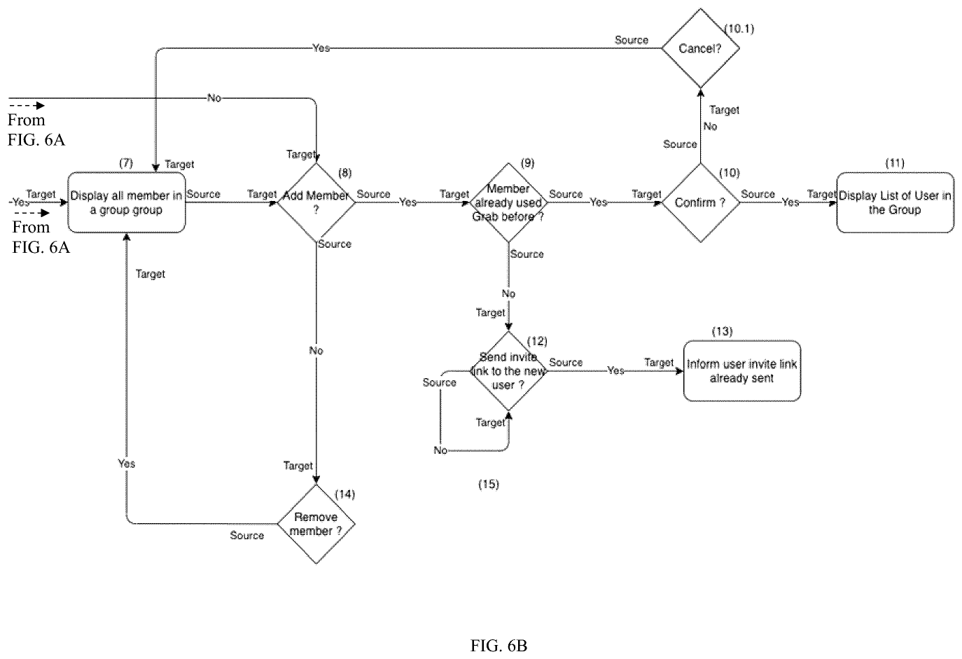

FIGS. 6A and 6B show an example of a process flow for a group management back end (BE) of various embodiments. In FIGS. 6A and 6B, the term “Source” refers to the output of the previous step, while the term “Target” refers to the input of the next step. Description is provided below in relation to FIGS. 6A and 6B with reference to FIGS. 5A to 5L.
At BE step (1) shown in FIG. 6A, the BE (e.g., server) checks whether there are groups created by the user (or group owner or account owner) 600. If at least one user group has been created, the process proceeds to BE step (4) and FE page 560c (FIG. 5C). If no user group has been created, the process proceeds to BE step (2) and FE page 560i (FIG. 5I).
At BE step (2), the BE checks for new group creation by the user 600. If the user 600 clicks on the “Add New Group” button 562i on page 560i, the process proceeds to BE step (3) and page 560j of FIG. 5J.
At BE step (3), the BE checks for the group name. If the user 600 already keyed in the group name, the process proceeds to BE step (3.1).
At BE step (3.1), the BE checks whether the inputted group name exists. If the group name already exists, then the user 600 needs to key in a different group name. If the group name does not exist for any user group, the process proceeds to BE step (8) shown in FIG. 6B.
At BE step (4), the BE loads all group(s) which the user 600 belongs to and waits for action from the user 600 via page 560c (FIG. 5C).
At BE step (5), the BE checks whether the user 600 is creating a new group, similar to BE step (2). If the user 600 clicks on the “Add New Group” button 562c on page 560c, the process proceeds to BE step (3) and page 560j of FIG. 5J. If the user 600 does not click on the “Add New Group” button 562c, the process proceeds to BE step (6).
At BE step (6), the BE checks whether the user 600 clicks on any existing group. If the user 600 clicks on an existing group, the process proceeds to BE step (7) (FIG. 6B) and page 560d (FIG. 5D). If the user 600 does not click on an existing group, the process proceeds to BE step (15).
At BE step (7) shown in FIG. 6B, the BE loads all members in the group selected by the user 600 and waits for action from the user 600 via page 560d (FIG. 5D).
At BE step (8), the BE checks for addition of members to the group. If the user 600 clicks on the “Add” button 572d (FIG. 5D), the process proceeds to BE step (9) and page 560g (FIG. 5G). If the user 600 clicks on the tile (-) of a particular member, then the process proceeds to BE step (14).
At BE step (9), the BE checks whether the new member to be added uses a corresponding App for the subscription platform. If the new member already used the corresponding App before, then, the user 600 is allowed to click on the “Confirm” button 564g on page 560g (FIG. 5G). The process then proceeds to BE step (10). If the new member has never used the corresponding App before, the process proceeds to BE step (12).
At BE step (10), the BE checks for confirmation from the user 600. If the user 600 clicks on the “Confirm” button 564g on page 560g, the new member is added to the selected group and the process proceeds to BE step (11) and page 560h (FIG. 5H). If the user 600 does not click on the “Confirm” button 564g, the process proceeds to BE step (10.1).
At BE step (10.1), the BE checks for cancellation from the user 600. If the user 600 clicks on the “Cancel” button 566g on page 560g, then the BE cancels all changes made and the process proceeds to BE step (7) and page 560d (FIG. 5D).
At BE step (11), the BE sends the list of members, after confirmation by the user 600 at BE step (10), to be displayed on page 560h (FIG. 5H).
At BE step (12), following from BE step (9) for new member(s) who have never used the corresponding App in the past, the BE checks whether an invite link is sent to the new member to be added to the group. If an invite link has already been sent to the new member via their associated phone number for the new member to download and use the corresponding App, the process proceeds to BE step (13) and page 560l (FIG. 5L). If an invite link has not been sent to the new member, then, the BE sends the invite link and the process proceeds to BE step (13) and page 560l.
At BE step (13), the BE informs the user 600 that an invite link has been sent to the new member to be added to the group, and displays on page 560l (FIG. 5L).
At BE step (14), the BE checks for removal of members. If the user 600 clicks on the tile (-) of a particular member in the group on page 560d (FIG. 5D), then, the BE removes that particular member and the process proceeds to BE step (7) and page 560e (FIG. 5E).
At BE step (15), the BE checks for removal of groups. If the user 600 clicks on the tile (-) of a particular group on page 560c (FIG. 5C), then, the BE removes that particular group and the process proceeds to BE step (4) and page 560f (FIG. 5F).

It will be appreciated that the invention has been described by way of example only. Various modifications may be made to the techniques described herein without departing from the spirit and scope of the appended claims. The disclosed techniques comprise techniques which may be provided in a stand-alone manner, or in combination with one another. Therefore, features described with respect to one technique may also be presented in combination with another technique.

1. A communications server apparatus for managing a subscription plan for a plurality of offering categories, comprising a processor and a memory, the communications server apparatus being configured, under control of the processor to execute instructions in the memory to:
in response to receiving subscription request data comprising at least one data field indicative of a request by a user for subscribing to the subscription plan for the plurality of offering categories,
generate, in one or more data records, subscription data indicative of the subscription plan, the subscription data comprising a plurality of offering data for a corresponding plurality of offering categories to be covered in the subscription plan, wherein, for each offering data, the offering data comprises token data indicative of tokens associated with the corresponding offering category, the tokens being usable for offerings in the corresponding offering category; and
communicate the subscription plan to a communications device of the user.

2. The communications server apparatus as claimed in claim 1, wherein, for the each offering data, the token data comprises token number data indicative of a number of the tokens associated with the corresponding offering category.

3. The communications server apparatus as claimed in claim 1, wherein, for the each offering data, the token data comprises time data indicative of one or more time periods that the tokens are available.

4. The communications server apparatus as claimed in claim 1, wherein, for generating the subscription data, the communications server apparatus is configured to generate the token data for the plurality of offering categories based on output data generated by one or more machine learning models trained using user historical data.

5. The communications server apparatus as claimed in claim 1, wherein, in response to receiving user input data corresponding to the tokens, for generating the subscription data, the communications server apparatus is further configured to modify the token data in accordance with the user input data.

6. The communications server apparatus as claimed in claim 1, wherein, in response to receiving add request data indicative of a request by the user to include an additional offering category in the subscription plan, for generating the subscription data, the communications server apparatus is further configured to generate additional offering data for the additional offering category, the additional offering data comprising additional token data indicative of tokens associated with the additional offering category.

7. The communications server apparatus as claimed in claim 1, wherein, in response to receiving group request data indicative of a request by the user to include a group comprising the user as a group member and one or more additional group members in the subscription plan, for generating the subscription data, the communications server apparatus is further configured to, generate, for each additional group member, a plurality of offering data for a corresponding plurality of offering categories to be covered in the subscription plan, wherein, for each offering data, the offering data comprises token data indicative of tokens associated with the corresponding offering category.

8. The communications server apparatus as claimed in claim 7, wherein, for the each offering data for the each additional group member, the token data comprises token number data indicative of a number of the tokens associated with the corresponding offering category.

9. The communications server apparatus as claimed in claim 7, wherein, for the each offering data for the each additional group member, the token data comprises time data indicative of one or more time periods that the tokens are available.

10. The communications server apparatus as claimed in claim 7, wherein, for generating the subscription data, the communications server apparatus is configured to generate the token data for the plurality of offering categories for the each additional group member based on output data generated by one or more machine learning models trained using user historical data.

11. The communications server apparatus as claimed in claim 7, wherein, in response to receiving additional user input data corresponding to the tokens for the each additional group member, for generating the subscription data, the communications server apparatus is further configured to modify the token data for the each additional group member in accordance with the additional user input data.

12. The communications server apparatus as claimed in claim 1, wherein, in response to receiving confirmation data comprising at least one data field indicative of a confirmation by the user to the subscription plan, the communications server apparatus is further configured to store the subscription data in a database.

13. A method for managing a subscription plan for a plurality of offering categories, the method comprising:
in response to receiving subscription request data comprising at least one data field indicative of a request by a user for subscribing to the subscription plan for the plurality of offering categories,
generating, in one or more data records, subscription data indicative of the subscription plan, the subscription data comprising a plurality of offering data for a corresponding plurality of offering categories to be covered in the subscription plan, wherein, for each offering data, the offering data comprises token data indicative of tokens associated with the corresponding offering category, the tokens being usable for offerings in the corresponding offering category; and
communicating the subscription plan to a communications device of the user.

14-26. (canceled)

27. A communications device for managing a subscription plan for a plurality of offering categories, comprising a processor and a memory, the communications device being configured, under control of the processor, to execute instructions in the memory to:
generate subscription request data indicative of a request by a user to subscribe to the subscription plan to cover the plurality of offering categories; and transmit the subscription request data to a communications server apparatus for processing.

28. The communications device as claimed in claim 27, further configured to
generate user input data indicative of a change made by the user to one or more parameters of tokens associated with the plurality of offering categories; and
transmit the user input data to the communications server apparatus for processing.

29. The communications device as claimed in claim 27, further configured to:
generate add request data indicative of a request by the user to include an additional offering category in the subscription plan; and
transmit the add request data to the communications server apparatus for processing.

30. The communications device as claimed in claim 27, further configured to:
generate group request data indicative of a request by the user to include a group comprising the user as a group member and one or more additional group members in the subscription plan; and
transmit the group request data to the communications server apparatus for processing.

31-36. (canceled)

37. A communications system for managing a subscription plan for a plurality of offering categories, comprising a communications server apparatus, at least one user communications device and communications network equipment operable for the communications server apparatus and the at least one user communications device to establish communication with each other therethrough,
wherein the at least one user communications device comprises a first processor and a first memory, the at least one user communications device being configured, under control of the first processor, to execute first instructions stored in the first memory to transmit, for receipt by the communications server apparatus for processing, subscription request data comprising at least one data field indicative of a request by a user for subscribing to the subscription plan for the plurality of offering categories; and
wherein the communications server apparatus comprises a second processor and a second memory, the communications server apparatus being configured, under control of the second processor, to execute second instructions stored in the second memory to:
in response to receiving data indicative of the subscription request data, generate, in one or more data records, subscription data indicative of the subscription plan, the subscription data comprising a plurality of offering data for a corresponding plurality of offering categories to be covered in the subscription plan, wherein, for each offering data, the offering data comprises token data indicative of tokens associated with the corresponding offering category, the tokens being usable for offerings in the corresponding offering category; and
communicate the subscription plan to the at least one user communications device.
